(19) United States
(12) Patent Application Publication
(10) Pub. No.: US 2024/0056636 A1
(43) Pub. Date: Feb. 15, 2024

(54) LOW-POWER CONTROL METHOD AND DEVICES THEREOF

(71) Applicant: SAMSUNG ELECTRONICS CO., LTD., Suwon-si (KR)

(72) Inventors: Youngchan WOO, Suwon-si (KR); Sungyong KIM, Suwon-si (KR); Boram LEE, Suwon-si (KR); Hyunduk CHO, Suwon-si (KR); Sunah KIM, Suwon-si (KR)

(21) Appl. No.: 18/495,119

(22) Filed: Oct. 26, 2023

Related U.S. Application Data
(63) Continuation of application No. PCT/KR2022/019552, filed on Dec. 5, 2022.

(30) Foreign Application Priority Data
Feb. 23, 2022 (KR) 10-2022-0023657
Mar. 3, 2022 (KR) 10-2022-0027525

(51) Int. Cl. H04N 21/443; H04N 21/442

(52) U.S. Cl. CPC H04N 21/4436; H04N 21/44218

(57) ABSTRACT

Disclosed are a low-power control method in a service area in which electronic devices including a first electronic device and one or more second electronic devices are registered, the low-power control method including: determining an effective device located in the service area from among the second electronic devices in response to reception of an operation signal of the first electronic device outputting a content over a first display; obtaining interest information including an interest level toward the effective device; and activating a low-power setting for the first electronic device based on the interest information.

### CROSS-REFERENCE TO RELATED APPLICATIONS

This application is a continuation of International Application No. PCT/KR2022/019552 designating the United States, filed on Dec. 5, 2022, in the Korean Intellectual Property Receiving Office and claiming priority to Korean Patent Application No. 10-2022-0023657 filed on Feb. 23, 2022, in the Korean Intellectual Property Office, and to Korean Patent Application No. 10-2022-0027525 filed on Mar. 3, 2022, in the Korean Intellectual Property Office, the disclosures of all of which are incorporated by reference herein in their entireties.

### BACKGROUND

### 1. Field

The disclosure relates to a low-power control method and devices of the low-power control method.

### 2. Description of Related Art

As Internet of things (IoT) technology advances, a smart home solution for integrated management of various electronic devices at home has been developed. The smart home solution may enable a more convenient way of controlling and managing various user devices such as laptops and personal computers (PCs), smart home appliances such as televisions (TVs), refrigerators, and artificial intelligence (AI) speakers, and other IoT devices, through a smartphone or a tablet used by each user at home.

For example, there may be a multi-screen usage situation where respective displays of a plurality of devices including, for example, a television (TV), a laptop computer, and a smartphone are turned on. In such a situation, even when the TV is on, a user may not concentrate on watching TV and perform other tasks such as being on a social networking service (SNS), playing a game, shopping, and/or watching a movie, using their smartphone. In this case, power may continue to be consumed not only by the smartphone with which the user is performing the other tasks but also by the TV the user is not watching. However, to set a power-saving function for a device currently not in use by the user, several steps may need to be taken. In addition, when two display devices, such as a second screen, are used together, executing each time the power-saving function for a device on which the user does not concentrate may increase inconvenience.

### SUMMARY

Embodiments of the disclosure activate a low-power setting for a first electronic device based on a changing interest level of a user toward a second electronic device while the first electronic device is displaying a content.

Embodiments of the disclosure adjust an intensity and an application range of a low-power setting based on a type of a task performed in a second electronic device and/or a duration of use of the second electronic device.

Embodiments of the disclosure determine whether to activate a low-power setting for a first electronic device without additional settings, based on a level of association between a first content displayed on the first electronic device and a second content displayed on a second electronic device and/or a predefined (e.g., specified) user interaction.

According to an example embodiment, there is provided a low-power control method performed in a service area of a power control module in which electronic devices including a first electronic device and one or more second electronic devices are pre-registered, the low-power control method including: determining an effective device located in the service area from among the second electronic devices, in response to receiving an operation signal of the first electronic device outputting a content over a first display; obtaining interest information including an interest level toward the effective device; and activating a low-power setting for the first electronic device based on the interest information.

According to an example embodiment, there is provided a low-power control method of a second electronic device in a service area in which electronic devices including a first electronic device and one or more second electronic devices are pre-registered, the low-power control method including: detecting information of at least one of duration of an input interaction of at least one of a touch input, a remote control input, or a typing input that occur in the second electronic device, or an eye gaze detected by the second electronic device; a power consumption amount of a task performed in the second electronic device; or a type of a content playing in the second electronic device; determining an interest level toward the second electronic device based on the detected information; and transmitting the interest information including the interest level.

According to an example embodiment, there is provided a power control module for low-power control of electronic devices in a service area in which electronic devices including a first electronic device and one or more second electronic devices are pre-registered, the power control module including: a communication interface comprising circuitry configured to receive an operation signal of the first electronic device outputting content over a first display; a processor configured to: determine an effective device located in the service area from among the second electronic devices in response to reception of the operation signal, obtain interest information including an interest level toward the effective device, and activate a low-power setting for the first electronic device based on the interest information; and a memory configured to store the interest information.

According to various example embodiments described herein, activating a low-power setting for a first electronic device based on an interest level of a user toward a second electronic device while the first electronic device is displaying a content may save power consumption of the first electronic device and enable efficient energy consumption at home.

Other features and aspects will be apparent from the following detailed description, the drawings, and the claims.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an electronic device in a network environment according to an embodiment;

FIGS. 2A and 2B are diagrams illustrating an environment in which a low-power control method is performed according to an embodiment;

FIG. 3 is a flowchart illustrating a low-power control method according to an embodiment;

FIG. 4 is a diagram illustrating an example of activating a low-power setting for a first electronic device according to an embodiment;

FIG. 5 is a flowchart illustrating a low-power control method according to an embodiment;

FIG. 6 is a flowchart illustrating a method of determining an interest level of a user by a second electronic device according to an embodiment;

FIG. 7 is a diagram illustrating operations performed among a first electronic device, a second electronic device, and a power control module to activate a low-power setting according to an embodiment;

FIG. 8 is a diagram illustrating operations performed among a first electronic device, a second electronic device, and a power control module to cancel activation of a low-power setting according to an embodiment;

FIG. 9 is a diagram illustrating examples of controlling a setting for a first electronic device by activating a low-power setting according to an embodiment;

FIGS. 10A, 10B and 10C are diagrams illustrating examples of activating a low-power setting for a first electronic device when there is a single effective device in a service area according to an embodiment;

FIG. 11 is a diagram illustrating a low-power control method performed when there is a single effective device in a service area according to an embodiment;

FIG. 12 is a diagram illustrating a low-power control method performed when there is a plurality of effective devices in a service area and the effective devices are located in different spaces according to an embodiment;

FIG. 13 is a diagram illustrating an example of obtaining approval of a user for activation of a low-power setting using an interested device (which is a device of interest) among a plurality of effective devices when there is a plurality of effective devices in a service area according to an embodiment;

FIG. 14 is a diagram illustrating an example of adjusting at least one of an intensity or an application range of a low-power setting for a first electronic device based on interest information according to an embodiment;

FIG. 15 is a flowchart illustrating a method of activating a low-power setting based on an interest level of a user according to an embodiment;

FIG. 16 is a diagram illustrating an example of determining whether to activate a low-power setting based on a level of association according to an embodiment;

FIG. 17 is a diagram illustrating an example of determining whether to activate a low-power setting based on a level of association according to an embodiment;

FIGS. 18A and 18B are diagrams illustrating an example of canceling a low-power setting for a first electronic device in response to a predefined user input occurring in the first electronic device when the low-power setting for the first electronic device is activated according to an embodiment;

FIGS. 19, 20 and 21 are diagrams illustrating examples of canceling an activated low-power setting according to an embodiment;

FIG. 22 is a flowchart illustrating an example method of operating a second electronic device according to an embodiment; and

FIG. 23 is a block diagram illustrating an example configuration of a power control module according to an embodiment.

### DETAILED DESCRIPTION

Hereinafter, various example embodiments will be described in greater detail with reference to the accompanying drawings. When describing the embodiments with reference to the accompanying drawings, like reference numerals refer to like elements and a repeated description related thereto may not be provided.

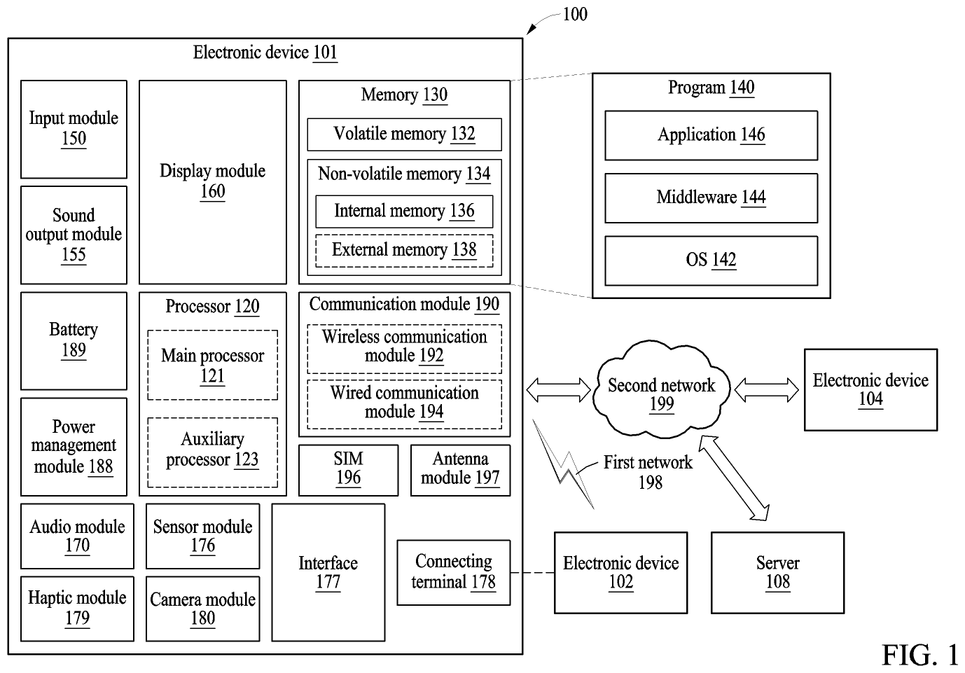

FIG. 1 is a block diagram illustrating an electronic device in a network environment according to an embodiments. Referring to FIG. 1, an electronic device 101 in a network environment 100 may communicate with an electronic device 102 via a first network 198 (e.g., a short-range wireless communication network), or communicate with at least one of an electronic device 104 and a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one (e.g., the connecting terminal 178) of the above components may be omitted from the electronic device 101, or one or more other components may be added to the electronic device 101. In various embodiments, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101 connected to the processor 120 and may perform various data processing or computations. According to an embodiment, as at least a part of data processing or computations, the processor 120 may store a command or data received from another component (e.g., the sensor module 176 or the communication module 190) in a volatile memory 132, process the command or data stored in the volatile memory 132, and store resulting data in a non-volatile memory 134. According to an embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently from or in conjunction with, the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display device 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specifically for artificial intelligence (AI) model processing. An AI model may be generated by machine learning. The machine learning may be performed by, for example, the electronic device 101, in which the AI model is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may alternatively or additionally include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134. The non-volatile memory 134 may include an internal memory 136 and an external memory 138.

The program 140 may be stored as software in the memory 130 and may include, for example, an operating system (OS) 142, middleware 144, or an application 146.

The application 146 may include, for example, home, dialer, SMS/MMS, instant message (IM), browser, camera, alarm, contacts, voice recognition, email, calendar, media player, album, watch, health (e.g., measurement of biometric information such as exercise volume or blood sugar), or environmental information (e.g., measurement of barometric pressure, humidity, or temperature information) applications. According to an embodiment, the application 146 may further include an information exchanging application (not shown) that supports information exchange between the electronic device 101 and an external electronic device. The information exchange application may include, for example, a notification relay application configured to transmit predetermined information (e.g., call, message, or alarm) to an external electronic device or a device management application configured to manage an external electronic device.

For example, the notification relay application may transmit, to an external electronic device, notification information corresponding to a predetermined event (e.g., receiving mail) occurring in another application (e.g., an email application) of the electronic device 101. The notification relay application may additionally or alternatively receive the notification information from the external electronic device and provide the notification information to the user of the electronic device 101.

For example, the device management application may control power (e.g., turn-on or turn-off) or functions (e.g., brightness, resolution, or focus) of an external electronic device communicating with the electronic device 101 or some components thereof (e.g., a display module or camera module of the external electronic device) or function (e.g.). The device management application may additionally or alternatively support installation, removal, or update of an application running on the external electronic device.

The input module 150 may receive, from outside (e.g., a user) the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a recording. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a display, a hologram device, or a projector, and a control circuitry for controlling a corresponding one of the display, the hologram device, and the projector. According to an embodiment, the display module 160 may include a touch sensor adapted to sense a touch, or a pressure sensor adapted to measure an intensity of a force of the touch.

The audio module 170 may convert sound into an electric signal or vice versa. According to an embodiment, the audio module 170 may obtain the sound via the input module 150 or output the sound via the sound output module 155 or an external electronic device (e.g., the electronic device 102, such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101 and generate an electric signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, an illuminance sensor, or a fingerprint sensor.

The interface 177 may support one or more specified protocols to be used by the electronic device 101 to couple with an external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may physically connect to an external electronic device (e.g., the electronic device 102). According to an embodiment, the connecting terminal 178 may include, for example, an HDMI connector, a USB connector, an SD card connector, or an audio connector (e.g., a headphones connector).

The haptic module 179 may convert an electric signal into a mechanical stimulus (e.g., a vibration or a movement) or an electrical stimulus, which may be recognized by a user via their tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, and flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell, which is not rechargeable, a secondary cell, which is rechargeable, or a fuel cell.

The communication module 190 may support establishing a direct (e.g., wired) communication channel or a wireless communication channel between the electronic device 101 and an external electronic device (e.g., the electronic device 102, the electronic device 104, or the server 108) and performing communication via the established communication channel. The communication module 190 may include one or more CPs that are operable independently from the processor 120 (e.g., an AP) and that support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device, for example, the electronic device 104, via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network and next-generation communication technology (e.g., new radio (NR) access technology). The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an antenna array, analog beamforming, or a large-scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., an antenna array). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to various embodiments, the antenna module 197 may form a mmWave antenna module. According to an embodiment, the mmWave antenna module may include a PCB, an RFIC on a first surface (e.g., a bottom surface) of the PCB, or adjacent to the first surface of the PCB and capable of supporting a designated high-frequency band (e.g., a mmWave band), and a plurality of antennas (e.g., an antenna array) disposed on a second surface (e.g., a top or a side surface) of the PCB, or adjacent to the second surface of the PCB and capable of transmitting or receiving signals in the designated high-frequency band.

At least some of the above-described components may be coupled mutually and exchange signals (e.g., commands or data) therebetween via an inter-peripheral communication scheme (e.g., a bus, general-purpose input and output (GPIO), serial peripheral interface (SPI), or mobile industry processor interface (MIPI)).

According to an embodiment, commands or data may be transmitted or received between the electronic device 101 and the external electronic device (e.g., the electronic device 104) via the server 108 coupled with the second network 199. Each of the external electronic devices (e.g., the electronic device 102 and 104) may be a device of the same type as or a different type from the electronic device 101.

According to an embodiment, all or some of operations to be executed by the electronic device 101 may be executed by one or more of the external electronic devices (e.g., the electronic devices 102 and 104, and the server 108). For example, if the electronic device 101 needs to perform a function or a service automatically, or in response to a request from a user or another device, the electronic device 101, instead of, or in addition to, executing the function or the service, may request one or more external electronic devices to perform at least a part of the function or service. The one or more external electronic devices receiving the request may perform the at least part of the function or service requested, or an additional function or an additional service related to the request, and may transfer a result of the performance to the electronic device 101. The electronic device 101 may provide the result, with or without further processing of the result, as at least a part of a response to the request. To that end, cloud computing, distributed computing, mobile edge computing (MEC), or client-server computing technology may be used, for example. The electronic device 101 may provide ultra-low latency services using, e.g., distributed computing or MEC. In an embodiment, the external electronic device (e.g., the electronic device 104) may include an Internet-of-things (IoT) device. The server 108 may be an intelligent server using machine learning and/or a neural network. According to an embodiment, the external electronic device (e.g., the electronic device 104) or the server 108 may be included in the second network 199. The electronic device 101 may be applied to intelligent services (e.g., a smart home, a smart city, a smart car, or healthcare) based on 5G communication technology or IoT-related technology.

According to various embodiments described herein, an electronic device may be a device of one of various types. The electronic device may include, as non-limiting examples, a portable communication device (e.g., a smartphone, etc.), a computing device, a portable multimedia device, a portable medical device, a camera, a wearable device, a home appliance, or the like. However, the electronic device is not limited to the examples described above.

It should be appreciated that various embodiments of the present disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things unless the relevant context clearly indicates otherwise. As used herein, “A or B,” “at least one of A and B,” “at least one of A or B,” “A, B, or C,” “at least one of A, B, and C,” and “A, B, or C,” each of which may include any one of the items listed together in the corresponding one of the phrases, or all possible combinations thereof. Terms such as “first,” “second,” or “initial” or “next” or “subsequent” may simply be used to distinguish the component from other components in question, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), the element may be coupled with the other element directly (e.g., by wire), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in the form of an application-specific integrated circuit (ASIC).

An embodiment set forth herein may be implemented as software (e.g., the program 140) including one or more instructions that are stored in a storage medium (e.g., the internal memory 136 or the external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to various embodiments, a method according to an embodiment of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™) or between two user devices (e.g., smart phones) directly. If distributed online, at least part of the computer program product may be temporarily generated or at least temporarily stored in the machine-readable storage medium, such as a memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

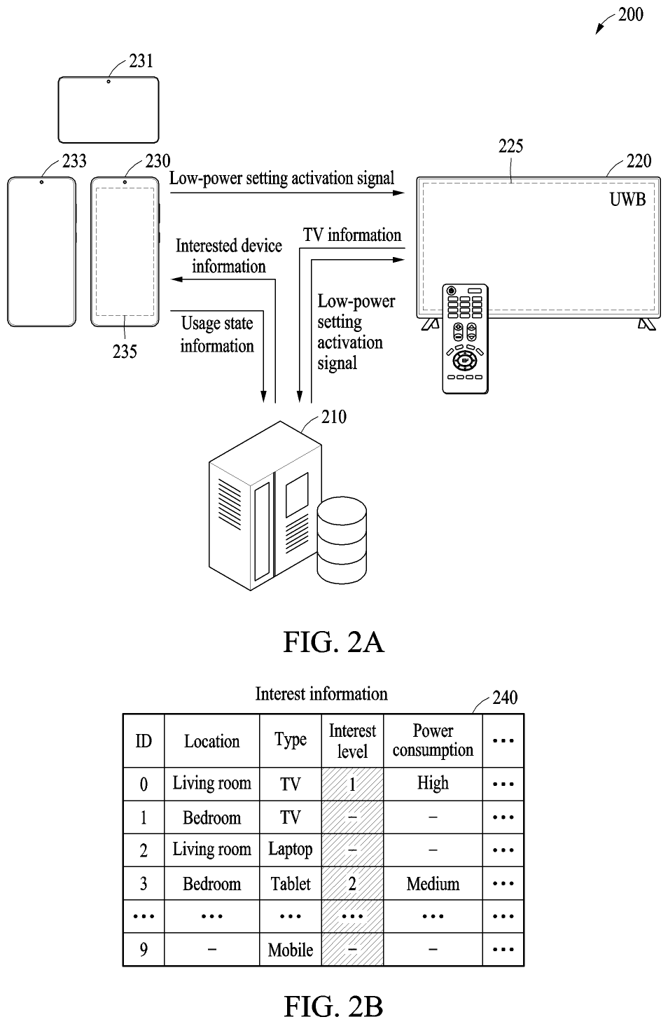

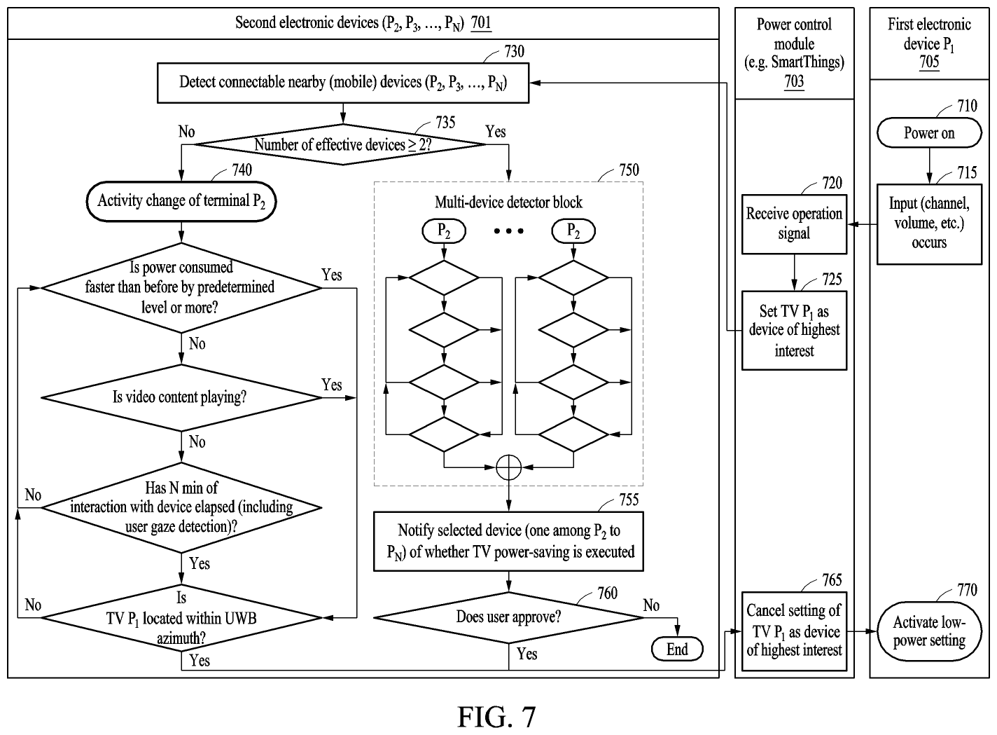

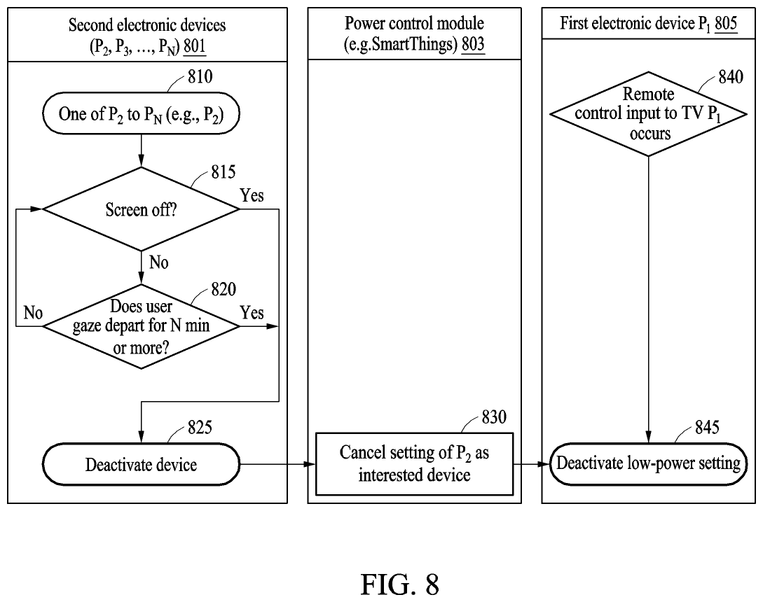

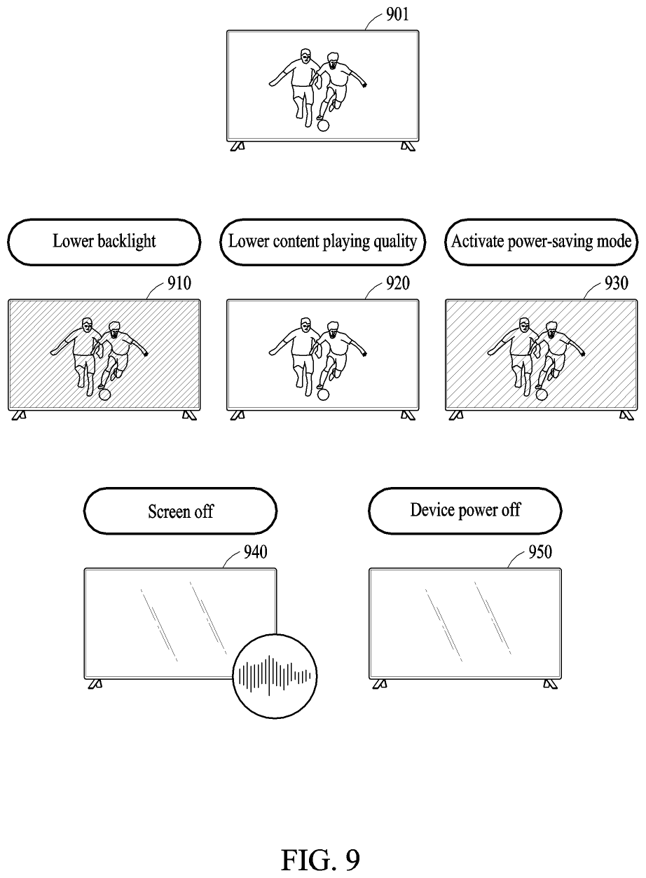

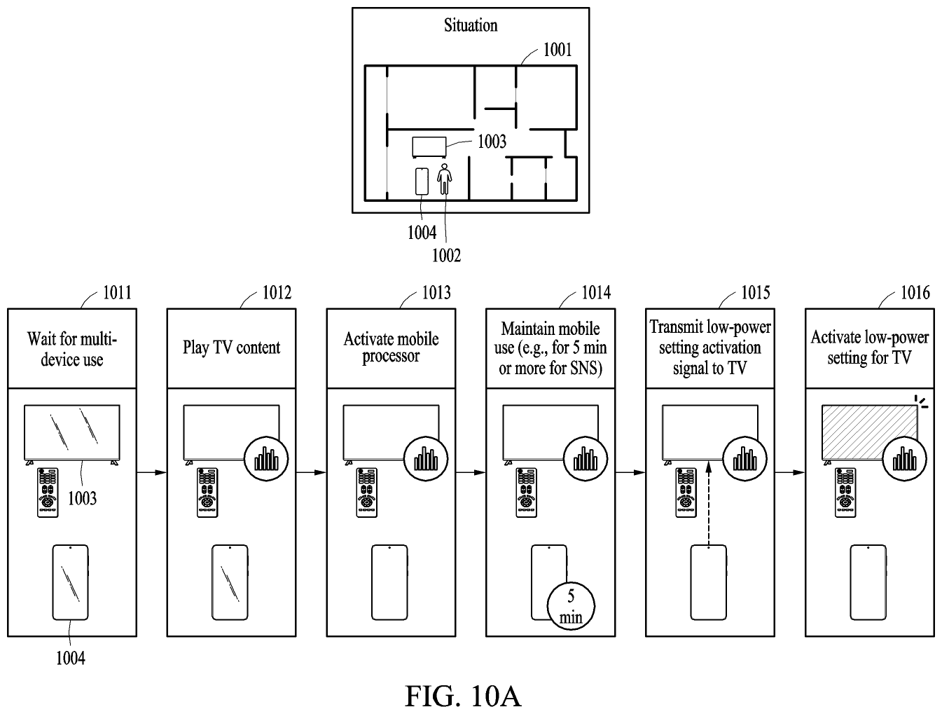

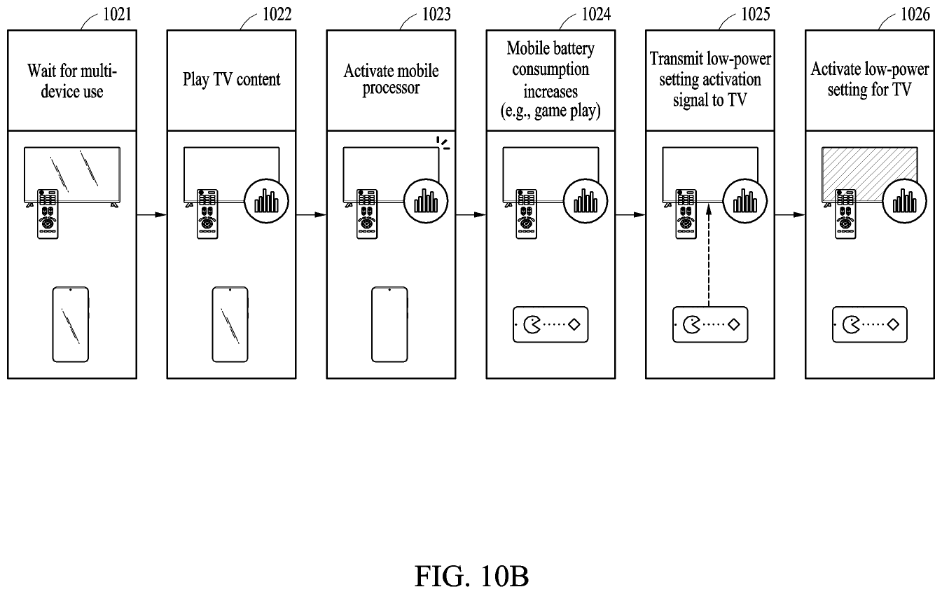

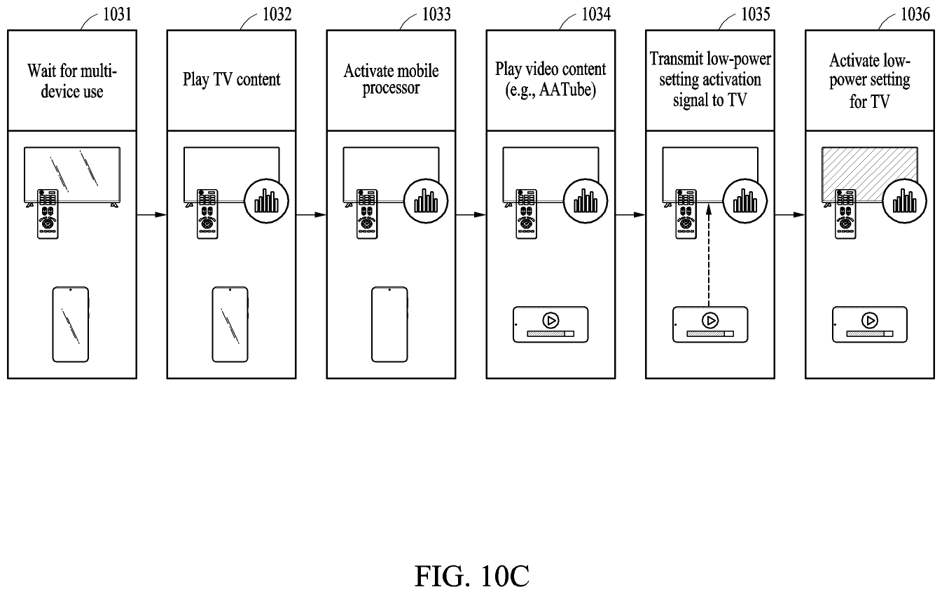

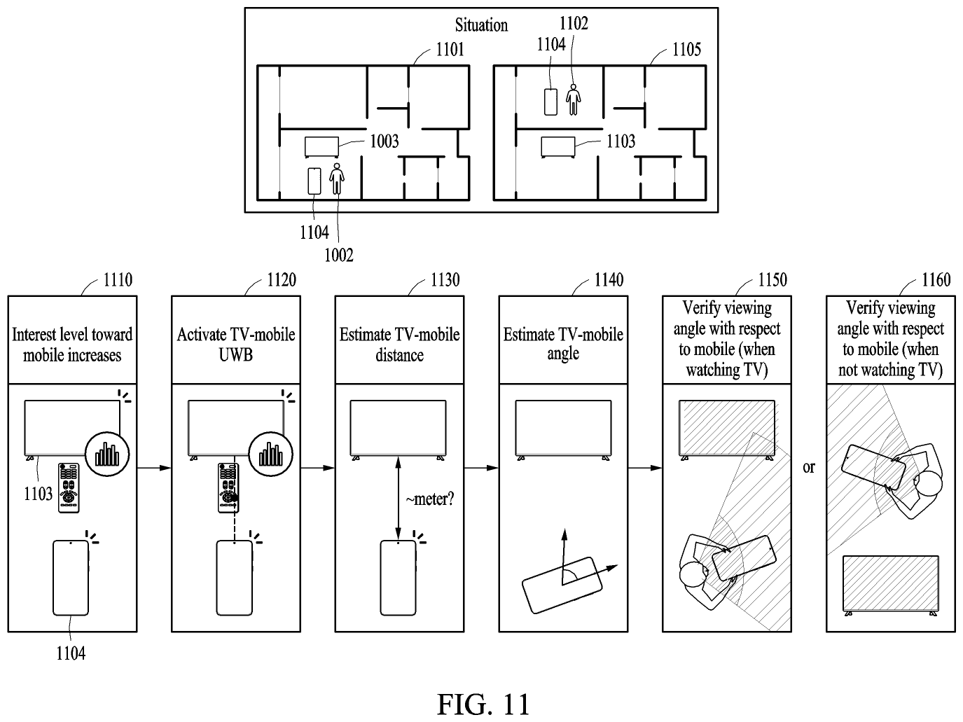

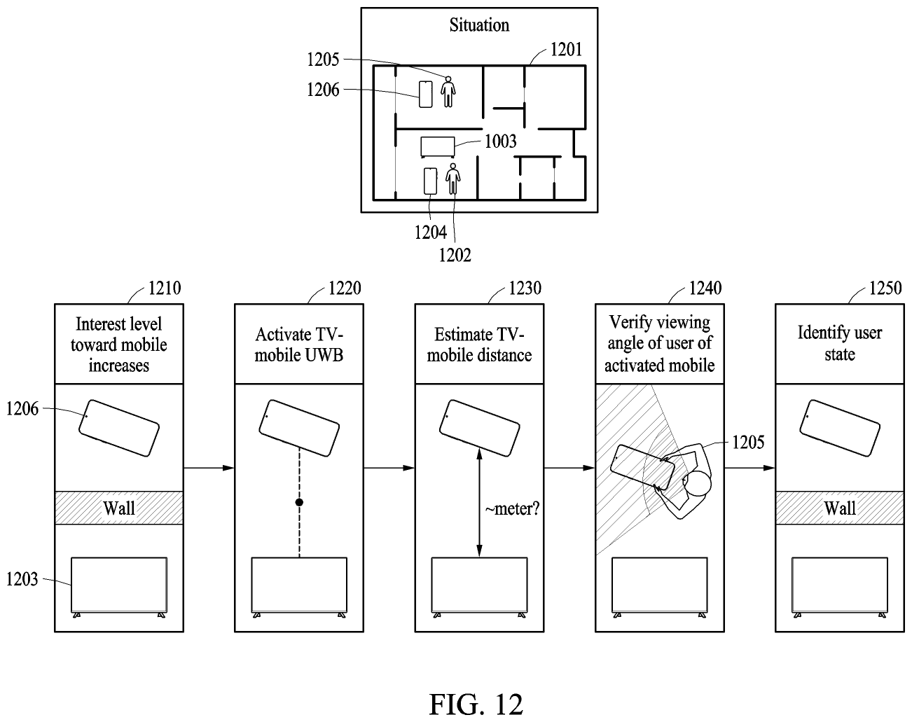

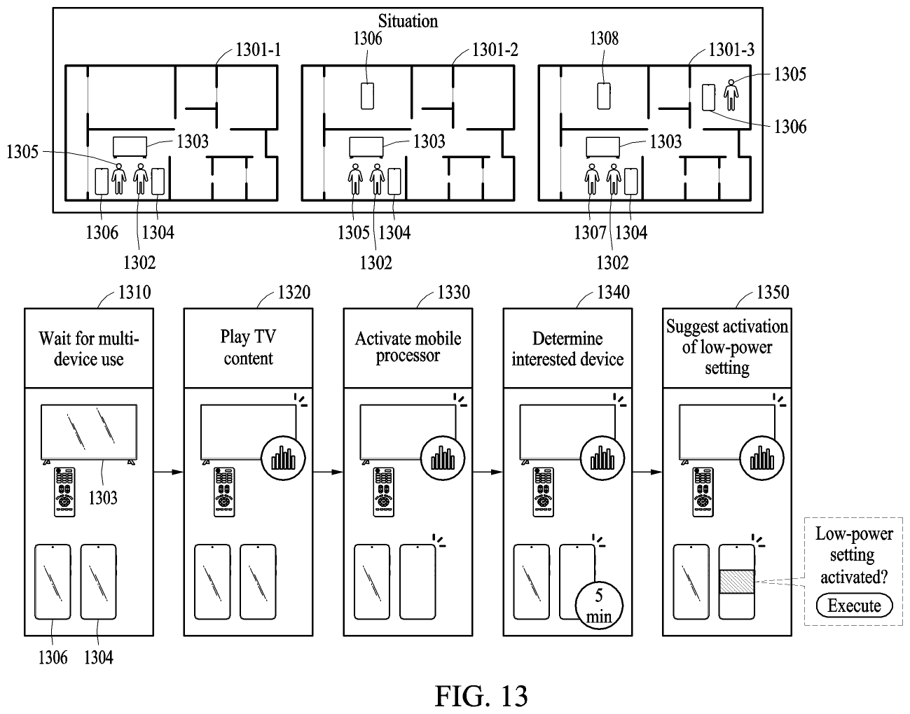

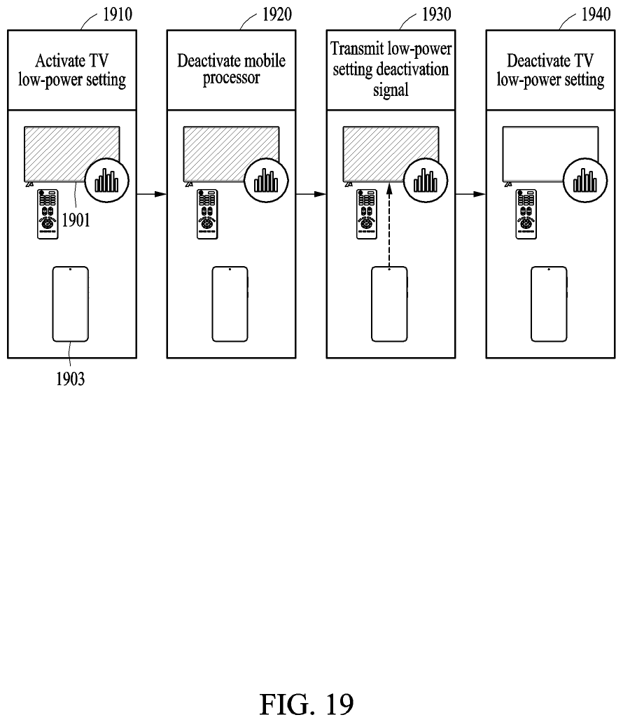

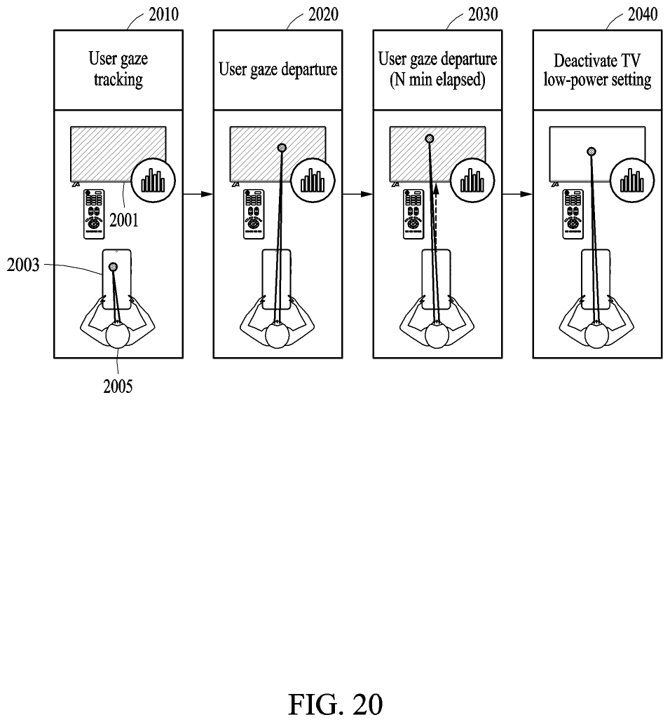

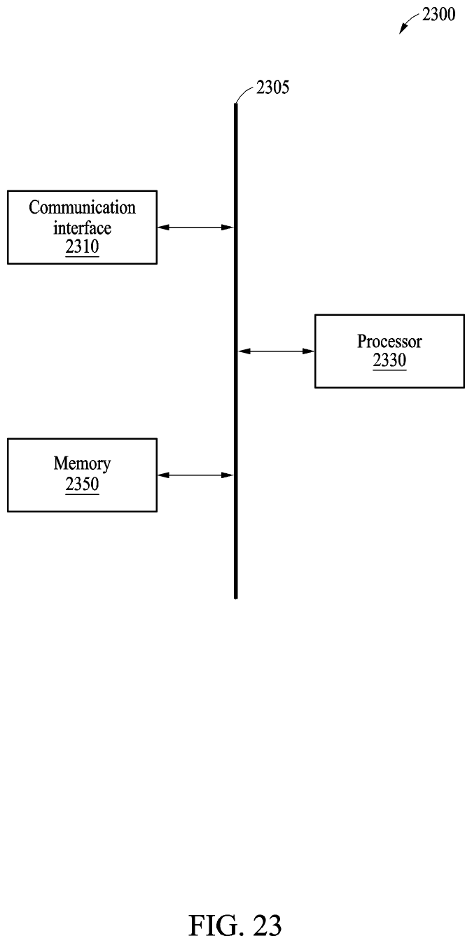

FIGS. 2A and 2B are diagrams illustrating an environment in which a low-power control method is performed according to an embodiment. Referring to FIGS. 2A and 2B, a network environment according to an embodiment may include a power control module (e.g., including power control circuitry) 210 (e.g., a power control module 703 of FIG. 7, a power control module 803 of FIG. 8, and/or a power control module 2300 of FIG. 23), a first electronic device 220 (e.g., the electronic devices 101 and 102 of FIG. 1, a first electronic device 705 of FIG. 7, a first electronic device 805 of FIG. 8, a first electronic device 901 of FIG. 9, a first electronic device 1003 of FIG. 10A, a first electronic device 1103 of FIG. 11, a first electronic device 1203 of FIG. 12, a first electronic device 1303 of FIG. 13, a first electronic device 1901 of FIG. 19, and/or a first electronic device 2001 of FIG. 20), and an interested device 230 in which a user is interested.

The power control module 210 may include various power control circuitry and perform low-power control on electronic devices (e.g., electronic devices 220, 230, 231, and 233) included in a predetermined (e.g., specified) service area. The “service area” used herein may refer to an area in a range in which a control signal of the power control module 210 is to be transmitted to the electronic devices 220, 230, 231, and 233 through wired communication and/or wireless communication. The service area may correspond to a predetermined space, such as, for example, at home, in a building, or in a vehicle, but examples of which are not limited thereto. The term “communication” between the power control module 210 and the electronic devices 220, 230, 231, and 233 may be performed using various communication circuitry and by a wireless communication protocol, such as, for example, Z-wave, Zigbee, and Wi-Fi, and/or by a wired communication protocol, but is not necessarily limited thereto.

The electronic devices 220, 230, 231, and 233 may be registered in advance with the power control module 210. The electronic devices 220, 230, 231, and 233 may include, for example, various user devices such as a smartphone, a tablet, a laptop, and a personal computer (PC), smart home appliances such as a television (TV), a refrigerator, and a speaker, and various Internet of Things (IoT) devices, but examples of which are not necessarily limited thereto. The electronic devices 220, 230, 231, and 233 may include the first electronic device 220 and one or more second electronic devices (e.g., the electronic devices 230, 231, and 233), but examples of which are not limited thereto.

The first electronic device 220 may be an electronic device that is a target of low power control. The first electronic device 220 may be, for example, a display device outputting a content over a first display 225, but is not limited thereto.

The term “content” described herein may include, for example, a multimedia content using visual modality and auditory modality, a video content using visual modality, and/or an audio content using auditory modality, but is not necessarily limited thereto.

The power control module 210 may receive device information, such as, for example, TV information, from the first electronic device 220, and receive usage state information from the second electronic devices 230, 231, and 233. The usage state information may be various sets of information associated with a state of a device, which includes, for example, interest information indicating an interest level of a user and information about an activity change of a device (e.g., power on/off, display on/off, and entry into a power-saving mode).

The power control module 210 may determine a second electronic device in which an activity change occurs in the service area from among the second electronic devices 230, 231, and 233, as an “effective device” (e.g., a mobile terminal 1004 of FIG. 10A, a mobile terminal 1104 of FIG. 11, mobile terminals 1204 and 1206 of FIG. 12, and/or mobile terminals 1304, 1306, and 1308 of FIG. 13). The “activity change” used herein may include, but is not limited to, the driving of a processor in a corresponding device, execution of a specific application (app) in a corresponding device, and generation of power consumption greater than a predetermined reference in a corresponding device.

The power control module 210 may determine the interested device 230 corresponding to the user based on the number of effective devices. The “interested device” 230 used herein may refer to a device of interest on which the interest of the user currently focuses. The power control module 210 may transmit interested device information indicating that a corresponding device is determined as a device of interest or a device of highest interest.

For example, when there is one effective device in the service area, the power control module 210 may determine this effective device as the interested device 230 corresponding to the user. When there are a plurality of effective devices in the service area, the power control module 210 may determine the interested device 230 corresponding to the user based on interest information (e.g., interest information 240 of FIG. 2B) corresponding to each of the effective devices. In this case, the interest information 240 corresponding to each of the effective devices may include, for example, identification information (e.g., ID) corresponding to each effective device, a location of each effective device, a type (e.g., a TV, a laptop, a tablet, a mobile, etc.) of each effective device, a level (e.g., 1 to 5) of interest of the user toward each effective device, and a power consumption amount of each effective device, but examples of which are not necessarily limited thereto.

For example, the level of interest of the user (or simply an interest level of the user herein) may be determined by a second electronic device (or an effective device) and received by the power control module 210, or may be determined directly by the power control module 210 based on information transmitted after being detected from each effective device. The interest level of the user may be determined based on, for example, duration of an input interaction of at least one of a touch input, a remote control input, a typing input (which occurs in each second electronic device such as the interested device 230), or a gaze of the (detected by a second electronic device); a power consumption amount of a task performed in a second electronic device; and a type of a content playing in a second electronic device, but examples of which are not limited thereto.

The interest information 240 may be stored in, as non-limiting examples, a memory of the power control module 210 or a storage of a cloud server, etc.

The power control module 210 may activate a low-power setting for the first electronic device 220 based on the interest information. The power control module 210 may activate the low-power setting by any one of or a combination of, for example, a setting to lower backlight of the first display 225, a setting to lower a playing quality of a content output from the first display 225, a setting to lower a sound of the first electronic device 220, a setting to activate a power-saving mode of the first electronic device 220, and a setting to turn off power of the first electronic device 220, but is not necessarily limited thereto. In addition to this, the power control module 210 may activate the low-power setting in various ways to reduce power consumption of the first electronic device 220.

According to an embodiment, the interested device 230 may transmit a low-power setting activation signal in place of the power control module 210 to activate the low-power setting for the first electronic device 220.

The power control module 210 may adjust at least one of an intensity or an application range of the low-power setting for the first electronic device 220 based on the interest information.

In addition, the power control module 210 may determine whether to activate the low-power setting for the first electronic device 220 based on a level of association between a second content displayed on a second display 235 of the interested device 230 and a first content displayed on the first display 225 of the first electronic device 220. For example, when the level of association between the second content and the first content is greater than a preset (e.g., specified) reference, the power control module 210 may deactivate the low-power setting for the first electronic device 220. Conversely, when the level of association between the second content and the first content is less than or equal to the preset reference, the power control module 210 may activate the low-power setting for the first electronic device 220.

In this case, the level of association may be determined based on, for example, at least one of whether meta information of the first content matches a keyword input to the interested device 230, a similarity between the meta information of the first content and meta information of the second content, or whether the first content is playing the same on the interested device 230 through screen mirroring, but examples of which are not limited thereto.

For example, when the low-power setting is activated in the first electronic device 220, the power control module 210 may deactivate the low-power setting activated for the first electronic device 220 based on whether a predefined (e.g., specified) user input occurs in any one of the first electronic device 220 or the interested device 230.

The predefined user input may be a user input through which it is inferred that the interest of the user moves from the interested device 230 back to the first electronic device 220 or to another electronic device. The predefined user input may include, for example, a remote control input instructing at least one of a channel change, a volume change, or a power-saving mode cancel button of the first electronic device 220, an input that occurs in the interested device 230 and requests a state change from the activated low-power setting to an inactive state thereof, and a gaze departure of the user for a preset or more time detected by the interested device 230, but examples of which are not limited thereto.

When such a user input occurs in the first electronic device 220 or the interested device 230, the power control module 210 may cancel the activated low-power setting.

The power control module 210 may be included in, for example, a hub for integrated management of a smart home, a service server, a cloud server, or a second electronic device. Alternatively, the power control module 210 may be the hub, the service server, the cloud server, or the second electronic device itself.

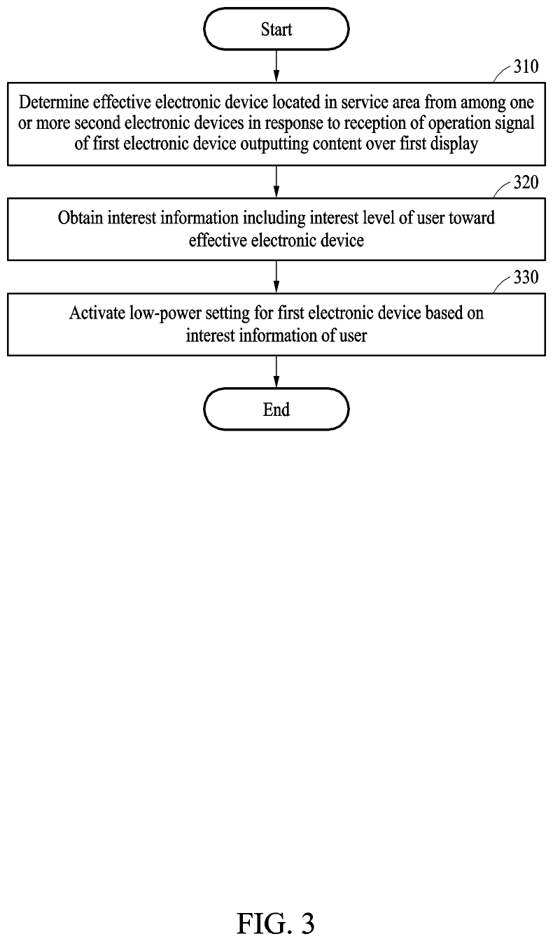

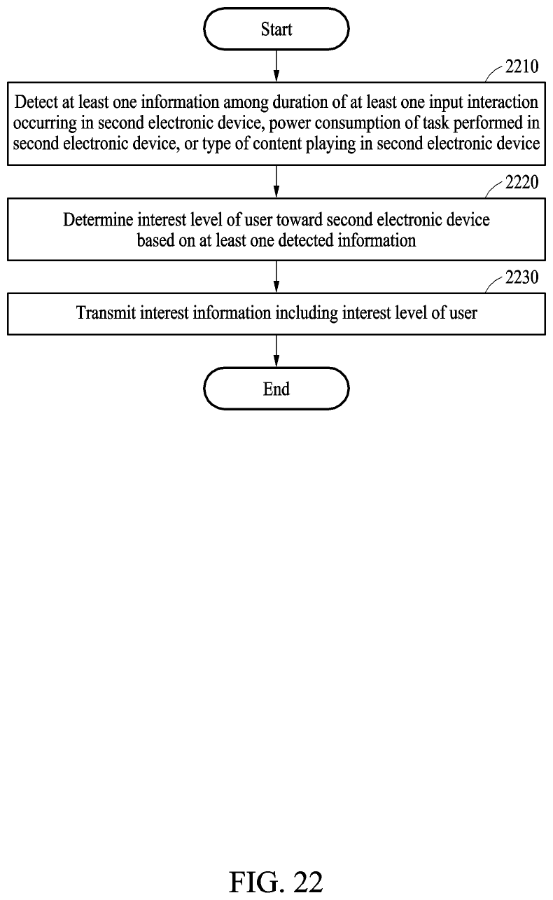

Hereinafter, an example operations of the power control module 210 will be described in greater detail with reference to FIGS. 3 to 21, and operations of a second electronic device (e.g., the interested device 230) will be described in greater detail with reference to FIG. 22.

FIG. 3 is a flowchart illustrating a low-power control method according to an embodiment. According to an embodiment, operations may be performed in sequential order, but not be necessarily performed in sequential order. For example, the order of the operations may be changed and at least two of the operations may be performed in parallel.

Referring to FIG. 3, a power control module (e.g., the power control module 210 of FIGS. 2A and 2B, the power control module 703 of FIG. 7, the power control module 803 of FIG. 8, and/or the power control module 2300 of FIG. 23) may activate a low-power setting for a first electronic device (e.g., the electronic devices 101 and 102 of FIG. 1, the first electronic device 220 of FIGS. 2A and 2B, the first electronic device 705 of FIG. 7, the first electronic device 805 of FIG. 8, the first electronic device 901 of FIG. 9, the first electronic device 1003 of FIG. 10A, the first electronic device 1103 of FIG. 11, the first electronic device 1203 of FIG. 12, the first electronic device 1303 of FIG. 13, the first electronic device 1901 of FIG. 19, and/or the first electronic device 2001 of FIG. 20) in a service area of the power control module 210 in which electronic devices including the first electronic device 220 and one or more second electronic devices (e.g., the electronic devices 101 and 102 of FIG. 1, the interested device 230 of FIGS. 2A and 2B, the second electronic device 701 of FIG. 7, the second electronic device 801 of FIG. 8, the second electronic device 1004 of FIG. 10A, the second electronic device 1104 of FIG. 11, the second electronic devices 1204 and 1206 of FIG. 12, the second electronic devices 1304, 1306, and 1308 of FIG. 13, the second electronic device 1903 of FIG. 19, and/or the second electronic device 2003 of FIG. 20) are registered in advance, through operations 310 through 330 described below.

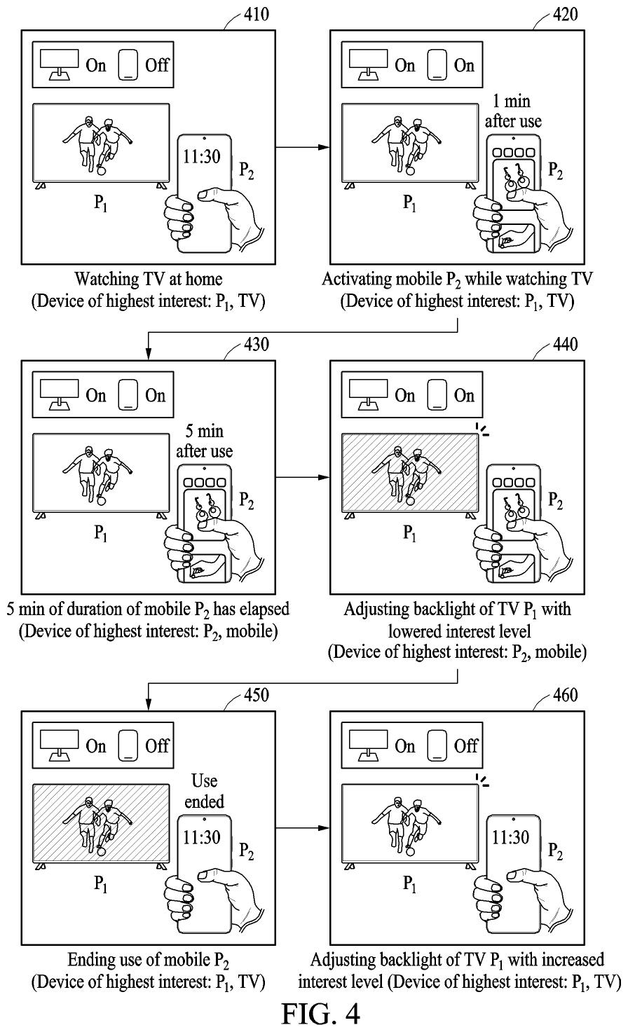

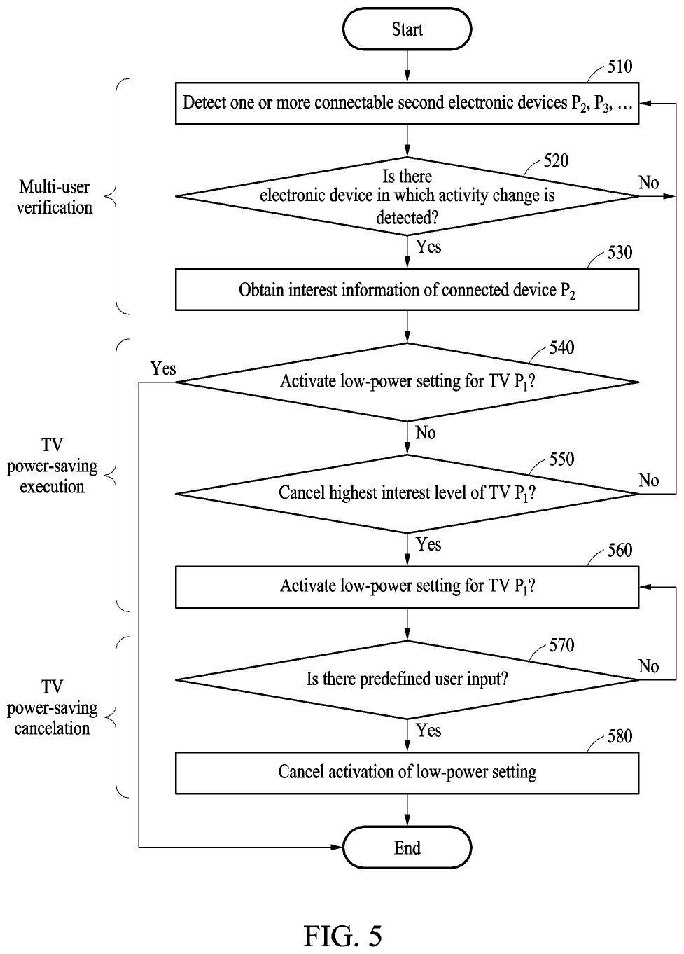

In operation 310, the power control module 210 may determine an effective device (e.g., a mobile terminal 1004 of FIG. 10A, a mobile terminal 1104 of FIG. 11, mobile terminals 1204 and 1206 of FIG. 12, and/or mobile terminals 1304, 1306, and 1308 of FIG. 13) located in the service area from among the second electronic devices, in response to an operation signal of the first electronic device 220 outputting a content over a first display (e.g., the first display 225 of FIGS. 2A and 2B) is received. The power control module 210 may detect the effective device in which an activity change occurs in the service area among the second electronic devices. A process in which the power control module 210 detects an effective device and activates a low-power setting for a first electronic device will be described in greater detail below with reference to FIGS. 4 and 5.

The power control module 210 may detect the number of effective devices in which the activity change occurs in the service area among the second electronic devices. The power control module 210 may determine an interested device corresponding to a user based on the detected number of effective devices. For example, when there is a single effective device, the power control module 210 may determine the effective device as the interested device corresponding to the user. In contrast, when there is a plurality of effective devices, the power control module 210 may determine any one of the effective devices as the interested device based on an interest level of the user toward each of the effective devices.

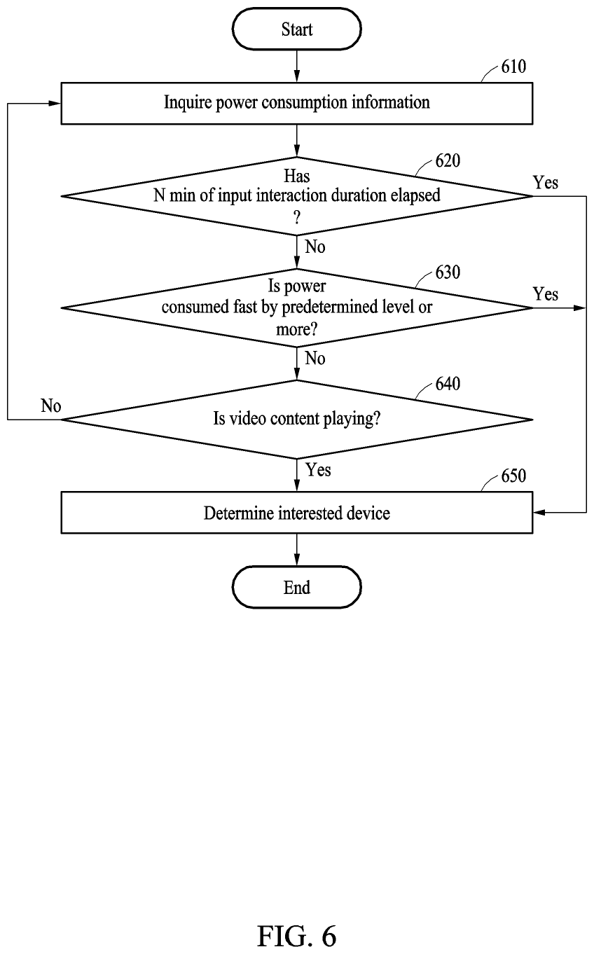

In this case, the interest level of the user corresponding to each of the effective devices may be determined as described below with reference to FIG. 6, for example.

In operation 320, the power control module 210 may obtain interest information including an interest level of the user toward the effective device. The interest level of the user may be determined based on, for example, at least one of duration of an input interaction of at least one of a touch input, a remote control input, a typing input, or an eye gaze; a power consumption amount of a task performed in the effective device; or a type of a content playing in the effective device, but examples of which are not limited thereto. In this case, the touch input, the remote control input, and the typing input may be an input that occurs in the effective device, and the eye gaze may be detected by the effective device. In this case, the duration of the input interaction may be determined differently for each type of effective device (e.g., a tablet, a laptop, a mobile, and a TV).

In operation 330, the power control module 210 may activate a low-power setting for the first electronic device 220 based on the interest information.

A process in which the power control module 210 determines an interested device corresponding to a user based on the number of effective devices and activates or cancels the low-power setting will be described in greater detail below with reference to FIGS. 7 and 8.

A method by which the power control module 210 controls a setting of a first electronic device according to the activation of a power setting will be described in greater detail below with reference to FIG. 9, and situations in which the power control module 210 activates the low-power setting for the first electronic device will be described in greater detail below with reference to FIGS. 10A to 10C.

For example, the power control module 210 may activate the low-power setting for the first electronic device based on the number of effective devices. A process in which the power control module 210 activates the low-power setting based on the number of effective devices will be described in greater detail below with reference to FIGS. 11 to 13.

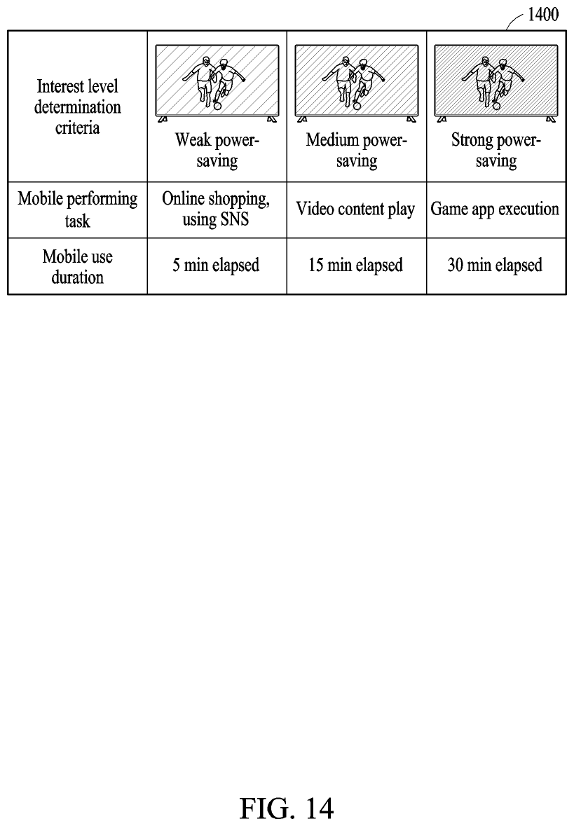

The power control module 210 may adjust at least one of an intensity and an application range of the low-power setting for the first electronic device based on the interest information. A method by which the power control module 210 adjusts at least one of an intensity and an application range of the low-power setting will be described in greater detail below with reference to FIG. 14.

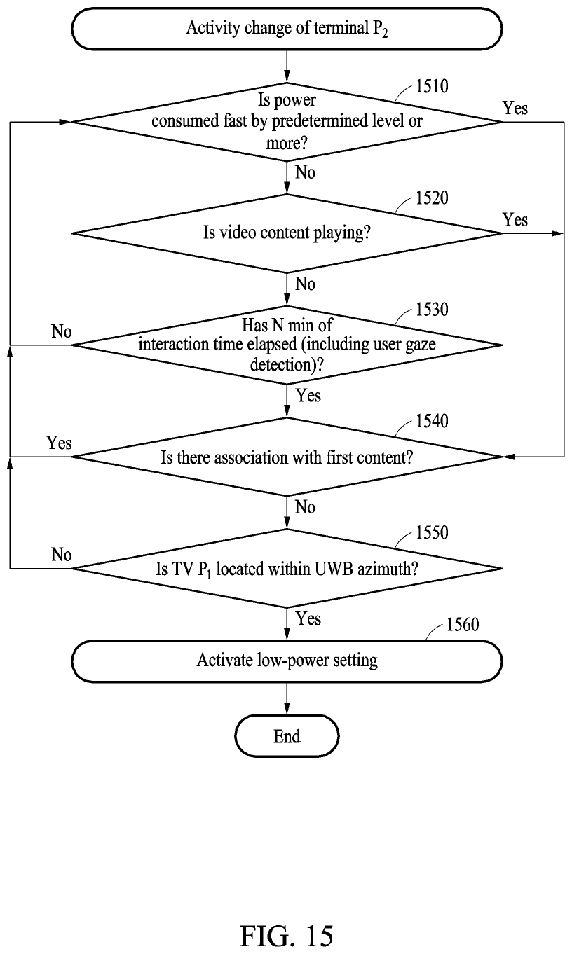

In addition, the power control module 210 may determine whether to activate the low-power setting for the first electronic device based on a level of association between a second content displayed on the interested device and a first content displayed on the first electronic device. A method by which the power control module 210 determines whether to activate a low-power setting for a first electronic device based on a level of association between a second content and a first content will be described in greater detail below with reference to FIGS. 15 to 17.

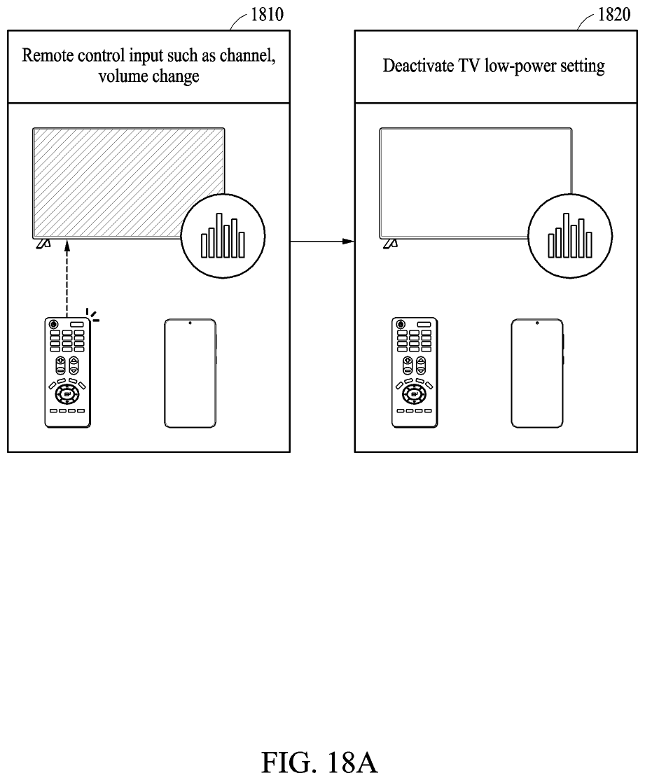

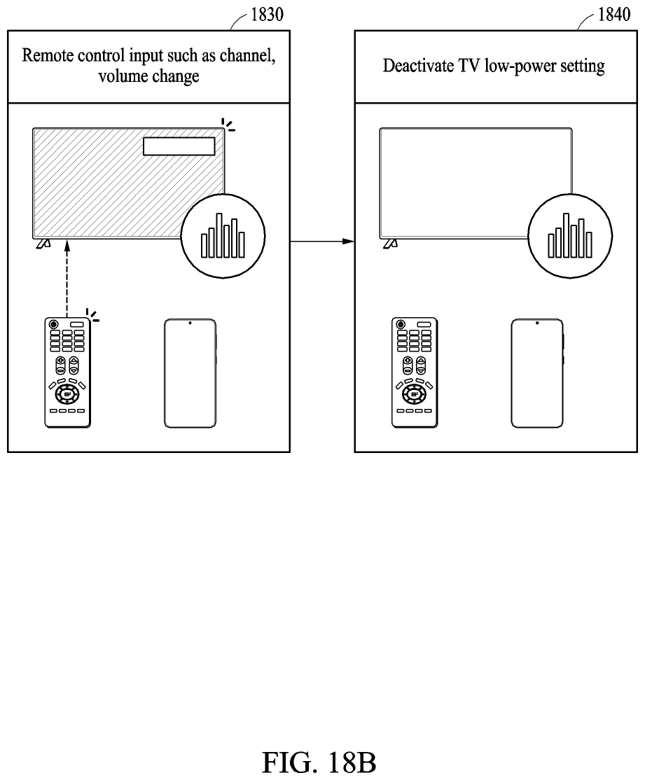

When the low-power setting is activated in the first electronic device, the power control module 210 may deactivate the low-power setting activated for the first electronic device based on whether a predefined user input occurs in any one of the first electronic device and the interested device. A method by which the power control module 210 deactivates a low-power setting by canceling an activated low-power setting will be described in greater detail below with reference to FIGS. 18 to 21.

In addition, when the predefined user input occurs in the first electronic device while the low-power setting is in an active state, the power control module 210 may cancel the low-power setting for the first electronic device.

FIG. 4 is a diagram illustrating an example of activating a low-power setting for a first electronic device according to an embodiment. Referring to FIG. 4, drawings 410, 420, 430, 440, 450, and 460 show an example process in which a power control module (e.g., the power control module 210 of FIGS. 2A and 2B, the power control module 703 of FIG. 7, the power control module 803 of FIG. 8, and/or the power control module 2300 of FIG. 23) activates a low-power setting for a first electronic device which is, for example, a TV P₁ as shown (e.g., the electronic devices 101 and 102 of FIG. 1, the first electronic device 220 of FIGS. 2A and 2B, the first electronic device 705 of FIG. 7, the first electronic device 805 of FIG. 8, the first electronic device 901 of FIG. 9, the first electronic device 1003 of FIG. 10A, the first electronic device 1103 of FIG. 11, the first electronic device 1203 of FIG. 12, the first electronic device 1303 of FIG. 13, the first electronic device 1901 of FIG. 19, and/or the first electronic device 2001 of FIG. 20), when an interested device of a user is changed from the first electronic device to a second electronic device which is, for example, a mobile terminal P₂ as shown (e.g., the electronic devices 101 and 102 of FIG. 1, the interested device 230 of FIGS. 2A and 2B, the second electronic device 701 of FIG. 7, the second electronic device 801 of FIG. 8, the second electronic device 1004 of FIG. 10A, the second electronic device 1104 of FIG. 11, the second electronic devices 1204 and 1206 of FIG. 12, the second electronic devices 1304, 1306, and 1308 of FIG. 13, the second electronic device 1903 of FIG. 19, and/or the second electronic device 2003 of FIG. 20).

For example, when the user watches the TV P₁ at home as shown in drawing 410, the TV P₁ may be determined as the interested device by the power control module 210. The user may activate the mobile terminal P₂ to be in an on state while watching the TV P₁ as shown in drawing 420, and there may be a separate input as the user continues using the mobile terminal P₂ for five minutes or more as shown in drawing 430. In this example, an interest level of the user toward the corresponding device may be determined by the separate input. The separate input may be, for example, at least one of duration of input interaction of at least one of a touch input, a remote control input, or a typing input that occurs in the mobile terminal P₂, or an eye gaze of the user detected by the mobile terminal P₂; a power consumption amount of a task performed in the mobile terminal P₂; or a type of a content playing in the mobile terminal P₂, but examples of which are not necessarily limited thereto. When such a separate input occurs, the power control module 210 may determine that the interested device in which the user is currently interested is not the TV P₁ but the mobile terminal P₂ and set the mobile terminal P₂ as the interested device.

When the mobile terminal P₂ is determined as the interested device, the power control module 210 may activate the low-power setting for the TV P₁ by, for example, controlling backlight of the TV P₁ toward which an interest level of the user is lowered, as shown in drawing 440. According to an embodiment, the power control module 210 may reduce power consumed by the TV P₁ in various ways including, for example, lowering a content playing quality of a content playing on the TV P₁, adjusting a combination of on/off states of a first display and a sound of the TV P₁, activating a power-saving mode of the TV P₁, or turning off the power of the TV P₁. In this case, the power control module 210 may activate the low-power setting for the first electronic device regardless of whether a screen timeout time preset for the first display of the TV P₁ has elapsed.

After the low-power setting for the TV P₁ is activated, the user may end using the mobile terminal P₂ as shown in drawing 450. For example, when a predefined user input, such as an input ending the use of the mobile terminal P₂, occurs, the power control module 210 may cancel the low-power setting for the TV P₁ by considering that the interest level of the user toward the TV P₁ has increased. In this case, the user input defined in advance to cancel the low-power setting may include, for example, a remote control input to the TV P₁ such as a channel change, a volume change, and a TV power-saving mode cancel button, a turned-off screen of the mobile terminal P₂, and a gaze departure of the user from the mobile terminal P₂, but examples of which are not necessarily limited thereto.

As the low-power setting for the TV P₁ is canceled, the power control module 210 may restore the backlight of the TV P₁ to a previous value shown in drawing 430, as shown in drawing 460.

According to an embodiment, the power control module 210 may activate the low-power setting to reduce a power consumption amount of the first electronic device in response to an interest level of the user toward the second electronic device while the first electronic device is displaying a content.

FIG. 5 is a flowchart illustrating a low-power control method according to another embodiment. According to an embodiment, operations may be performed in sequential order, but not be necessarily performed in sequential order. For example, the order of the operations may be changed and at least two of the operations may be performed in parallel.

Referring to FIG. 5, a power control module (e.g., the power control module 210 of FIGS. 2A and 2B, the power control module 703 of FIG. 7, the power control module 803 of FIG. 8, and/or the power control module 2300 of FIG. 23) may activate or cancel a low-power setting for a first electronic device (e.g., the electronic devices 101 and 102 of FIG. 1, the first electronic device 220 of FIGS. 2A and 2B, the first electronic device 705 of FIG. 7, the first electronic device 805 of FIG. 8, the first electronic device 901 of FIG. 9, the first electronic device 1003 of FIG. 10A, the first electronic device 1103 of FIG. 11, the first electronic device 1203 of FIG. 12, the first electronic device 1303 of FIG. 13, the first electronic device 1901 of FIG. 19, and/or the first electronic device 2001 of FIG. 20) based on an interest level of a user toward one or more second electronic devices (e.g., the electronic devices 101 and 102 of FIG. 1, the interested device 230 of FIGS. 2A and 2B, the second electronic device 701 of FIG. 7, the second electronic device 801 of FIG. 8, the second electronic device 1004 of FIG. 10A, the second electronic device 1104 of FIG. 11, the second electronic devices 1204 and 1206 of FIG. 12, the second electronic devices 1304, 1306, and 1308 of FIG. 13, the second electronic device 1903 of FIG. 19, and/or the second electronic device 2003 of FIG. 20) in a service area through operations 510 to 580 described below.

In operation 510, the power control module 210 may detect one or more connectable second electronic devices (e.g., P₂, P₃, P₄, . . . , and P_{N}) in the service area.

In operation 520, the power control module 210 may determine whether there is an electronic device in which an activity change is detected from among the second electronic devices detected in operation 510. When there is no electronic device with the detected activity change as a result of operation 520, the power control module 210 may perform operation 510 again.

In operation 530, when there is any one electronic device with the detected activity change, for example, a mobile terminal P₂, as the result of operation 520, the power control module 210 may obtain interest information including an interest level of the user toward the mobile terminal P₂. In this case, when the mobile terminal P₂ is only one electronic device in which the activity change is detected, the power control module 210 may determine the mobile terminal P₂ as an interested device (or a device of highest interest) and obtain the interest information including the interest level of the user corresponding to mobile terminal P₂. In this case, the interest level of the user may be determined through a process described in greater detail below with reference to FIG. 6, for example.

In operation 540, the power control module 210 may determine whether a low-power setting for the first electronic device (e.g., a TV P₁) is activated, based on the interest information obtained in operation 530. For example, when it is determined in operation 540 that the low-power setting for the TV P₁ is activated, the power control module 210 may end operations. In operation 550, when it is determined in operation 540 that the low-power setting for the TV P₁ is not activated, the power control module 210 may determine that the TV P₁ is no longer the interested device corresponding to the user by canceling the highest interest level toward the TV P₁.

In operation 560, the power control module 210 may activate the low-power setting for the TV P₁. For example, the power control module 210 may perform power saving by controlling a display method of a first display of the TV P₁ through a process to be described in greater detail below with referent to FIG. 7.

In operation 570, the power control module 210 may determine whether a user input predefined to cancel the activation of the low-power setting occurs in the TV P₁ or the mobile terminal P₂. The predefined user input may include, for example, at least one of a remote control input instructing at least one of a channel change, a volume change, and a power-saving mode cancel button of the TV P₁; an input that occurs in the mobile terminal P₂ and requests a state change from the activated low-power setting to an inactive state; or a gaze departure of the user for a preset or more time detected by the mobile terminal P₂, but examples of which are not limited thereto.

When it is determined in operation 570 that the predefined user input does not occur, the power control module 210 may maintain the low-power setting for the TV P₁. In operation 580, when it is determined in operation 570 that the predefined user input occurs, the power control module 210 may deactivate the low-power setting for the TV P₁ to allow the low-power setting to be inactive. The power control module 210 may cancel the activation of the low-power setting through a process to be described in greater detail below with reference to FIG. 8, for example.

FIG. 6 is a flowchart illustrating a method of determining an interest level of a user by a second electronic device according to an embodiment. According to an embodiment, operations may be performed in sequential order, but not be necessarily performed in sequential order. For example, the order of the operations may be changed and at least two of the operations may be performed in parallel.

Referring to FIG. 6, a power control module (e.g., the power control module 210 of FIGS. 2A and 2B, the power control module 703 of FIG. 7, the power control module 803 of FIG. 8, and/or the power control module 2300 of FIG. 23) may determine an interested device through operations 610 to 650 described below. Operations 610 to 640 described below with reference to FIG. 6 may be performed directly by the power control module 210 or by a second electronic device (e.g., the electronic devices 101 and 102 of FIG. 1, the interested device 230 of FIGS. 2A and 2B, the second electronic device 701 of FIG. 7, the second electronic device 801 of FIG. 8, the second electronic device 1004 of FIG. 10A, the second electronic device 1104 of FIG. 11, the second electronic devices 1204 and 1206 of FIG. 12, the second electronic devices 1304, 1306, and 1308 of FIG. 13, the second electronic device 1903 of FIG. 19, and/or the second electronic device 2003 of FIG. 10).

In operation 610, the power control module 210 may retrieve or inquire power consumption information of the second electronic device 230. In this case, the power consumption information of the second electronic device 230 may be retrieved through, for example, a battery usage that is permanently tracked in the second electronic device 230 through an operating system (OS) or a separate power management service app running in the second electronic device 230, but is not necessarily limited thereto.

In operation 620, the power control module 210 may determine whether N minutes of duration of an input interaction occurring in the second electronic device 230 have elapsed. The input interaction may include, for example, at least one of a touch input, a remote control input, a typing input, or a gaze of the user detected by the second electronic device 230, but is not limited thereto. In operation 650, when it is determined in operation 620 that N minutes of the duration of the input interaction have elapsed, the power control module 210 may determine the second electronic device 230 as an interested device. The duration of the input interaction may be defined differently for each type of the second electronic device 230, for example, 5 minutes for a mobile terminal and 3 minutes for a PC. The duration of the input interaction may be defined differently for each task (e.g., shopping, online being on SNS, and playing a game) performed by the second electronic device 230.

In operation 630, when it is determined in operation 620 that N minutes of the duration of the input interaction have not elapsed, the power control module 210 may determine whether a power consumption amount is consumed faster than a power consumption amount retrieved in operation 610 by a predetermined level or more. In operation 650, when it is determined in operation 630 that the power consumption amount is consumed fast by the predetermined or more level in operation 630, the power control module 210 may determine the second electronic device 230 as the interested device.

In operation 640, when it is determined in operation 630 that the power consumption amount is not consumed fast by the predetermined level or more, the power control module 210 may determine whether a video content is playing on the second electronic device 230. In this case, whether the video content is playing may be determined based on whether a codec service executed in the second electronic device 230 plays the video content.

When it is determined in operation 640 that the video content is not playing, the power control module 210 may perform operation 610.

When it is determined in operation 640 that the video content is playing, the power control module 210 may determine the second electronic device 230 as the interested device in operation 650.

FIG. 7 is a diagram illustrating operations performed among a first electronic device, a second electronic device, and a power control module to activate a low-power setting according to an embodiment. Referring to FIG. 7, through operations 710, 715, 720, 725, 730, 735, 740, 750, 755, 760, 765 and 770 (which may be referred to as operations 710 to 770) performed among one or more second electronic devices P₂, P₃, . . . , and P_{N} 701 (e.g., the electronic devices 101 and 102 of FIG. 1, the interested device 230 of FIGS. 2A and 2B, the second electronic device 801 of FIG. 8, the second electronic device 1004 of FIG. 10A, the second electronic device 1104 of FIG. 11, the second electronic devices 1204 and 1206 of FIG. 12, the second electronic devices 1304, 1306, and 1308 of FIG. 13, the second electronic device 1903 of FIG. 19, and/or the second electronic device 2003 of FIG. 20), a power control module 703 (e.g., the power control module 210 of FIGS. 2A and 2B, the power control module 803 of FIG. 8, and/or the power control module 2300 of FIG. 23), and a first electronic device P₁ 705 (e.g., the electronic devices 101 and 102 of FIG. 1, the first electronic device 220 of FIGS. 2A and 2B, the first electronic device 805 of FIG. 8, the first electronic device 901 of FIG. 9, the first electronic device 1003 of FIG. 10A, the first electronic device 1103 of FIG. 11, the first electronic device 1203 of FIG. 12, the first electronic device 1303 of FIG. 13, the first electronic device 1901 of FIG. 19, and/or the first electronic device 2001 of FIG. 20), a low power setting for the first electronic device P₁ 705 may be activated.

As power of the first electronic device 705 is turned on in operation 710 and an input (e.g., a channel change and a volume change) to the first electronic device 705 occurs in operation 715, the power control module 703 may receive an operation signal of the first electronic device 705 in operation 720.

In operation 725, the power control module 703 may set, as an interested device (or a device of highest interest), the first electronic device 705 from which the operation signal is received first within a service area.

In operation 730, as the operation signal of the first electronic device 705 is received, the power control module 703 may detect a second electronic device (or an “effective device”) in which an activity change occurs in the service area among the second electronic devices 701.

In operation 735, the power control module 703 may determine whether the number of detected effective devices is two or more. The power control module 703 may determine an interested device corresponding to a user based on the number of effective devices.

For example, when it is determined in operation 735 that the number of effective devices is less than two, that is, there is one effective device, the power control module 703 may detect an activity change of the effective device (e.g., the terminal P₂). The detecting of the activity change may include, for example, determining whether the power is consumed fast by a predetermined or more level, whether a video content is playing, and whether N minutes of duration of an input interaction elapses as described above with reference to FIG. 6, and may further include determining whether the first electronic device 705 is located within a viewing angle of the effective device (e.g., the terminal P₂).

For example, when the activity change is detected in the effective device (e.g., the terminal P₂), the effective device (e.g., the terminal P₂) may notify the power control module 703 that the activity change has been detected. Accordingly, the power control module 703 may cancel the setting of the first electronic device 705 as the interested device in operation 765 and may activate a low-power setting for the first electronic device 705 in operation 765. In this case, the power control module 703 may set the effective device (e.g., the terminal P₂) as the interested device, instead of the first electronic device 705.

When it is determined in operation 735 that the number of effective devices is greater than or equal to two, the power control module 703 may detect the activity change in a plurality of effective devices and select, as the interested device, any one of the effective devices in which the user has the highest interest level from among the effective devices in operation 750.

In operation 755, the power control module 703 may notify the effective device selected in operation 750 of whether the low-power setting for the first electronic device 705 is executed, using a pop-up menu, for example.

In operation 760, the power control module 703 may determine whether approval for the pop-up menu used for the notification in operation 755 is received from a user of the effective device. When it is determined in operation 760 that the approval of the user is not received, the power control module 703 may end operations.

When it is determined in operation 760 that the approval of the user is received, the power control module 703 may cancel the setting of the first electronic device 705 as the interested device in operation 765 and may activate the low-power setting for the first electronic device 705 in operation 770.

FIG. 8 is a diagram illustrating operations performed among a first electronic device, a second electronic device, and a power control module to cancel activation of a low-power setting according to an embodiment. Referring to FIG. 8, through operations 810, 815, 820, 825, 830, 840 and 845 (which may be referred to as operations 810 to 845) among one or more second electronic devices P₂, P₃, . . . , and P_{N} 801 (e.g., the electronic devices 101 and 102 of FIG. 1, the interested device 230 of FIGS. 2A and 2B, the second electronic device 701 of FIG. 7, the second electronic device 1004 of FIG. 10A, the second electronic device 1104 of FIG. 11, the second electronic devices 1204 and 1206 of FIG. 12, the second electronic devices 1304, 1306, and 1308 of FIG. 13, the second electronic device 1903 of FIG. 19, and/or the second electronic device 2003 of FIG. 20), a power control module 803 (e.g., the power control module 210 of FIGS. 2A and 2B, the power control module 703 of FIG. 7, and/or the power control module 2300 of FIG. 23), and a first electronic device P₁ 805 (e.g., the electronic devices 101 and 102 of FIG. 1, the first electronic device 220 of FIGS. 2A and 2B, the first electronic device 705 of FIG. 7, the first electronic device 901 of FIG. 9, the first electronic device 1003 of FIG. 10A, the first electronic device 1103 of FIG. 11, the first electronic device 1203 of FIG. 12, the first electronic device 1303 of FIG. 13, the first electronic device 1901 of FIG. 19, and/or the first electronic device 2001 of FIG. 20), a low-power setting for the first electronic device P₁ 805 may be canceled.

For example, when a signal indicating that an interest level of a user toward the second electronic devices 801 has been lowered is received, the power control module 803 may deactivate the low-power setting for the first electronic device 805 by canceling the setting of a second electronic device 801 determined as an interested device and cancelling the activation of the low-power setting for the first electronic device 805.

In this example, the signal indicating that the interest level of the user toward the second electronic device 801 may correspond to, for example, a state change to an inactive state of the second electronic device 801 (e.g., a screen-off state of the second electronic device 801 and a suspended processing state of the second electronic device 801), a gaze departure of the user verified for a preset or more time in an input device (e.g., a sensor module and/or camera module) of the second electronic device 801, or a remote input to the first electronic device 805, but is not limited thereto.

For example, in operation 810, the second electronic device 801 (e.g., P₂) (or the interested device) may be determined from among the second electronic devices 801, and the low-power setting for the first electronic device 805 may be activated.

In this case, in operation 815, the second electronic device 801 may determine whether a change to the inactive state such as screen-off occurs. When it is determined in operation 815 that the change to the inactive state occurs, the second electronic device 801 may be deactivated in operation 825. As the second electronic device 801 is deactivated, the power control module 803 may cancel the setting of the second electronic device 801 as the interested device in operation 830 and deactivate the low-power setting for the first electronic device 805 in operation 845.

When it is determined in operation 815 that the change to the inactive state does not occur, the second electronic device 801 may determine whether a gaze of the user departs for N or more minutes in operation 820. When it is determined in operation 820 that the gaze of the user does not depart for N or more minutes, the second electronic device 801 may perform operation 815.

When it is determined in operation 820 that the gaze of the user departs for N or more minutes, the second electronic device 801 may be deactivated in operation 825. As the second electronic device 801 is deactivated, the power control module 803 may cancel the setting of the second electronic device 801 as the interested device in operation 830 and may deactivate the low-power setting for the first electronic device 805 in operation 845.

In addition, when a remote control input to the first electronic device 805 occurs in operation 840, the power control module 803 may deactivate the low-power setting for the first electronic device 805 in operation 845 to change the low-power setting for the first electronic device 805 to the previous inactive state to reduce power consumption of the first electronic device 805.

FIG. 9 is a diagram illustrating examples of controlling a setting for a first electronic device by activating a low-power setting according to an embodiment. Referring to FIG. 9, shown is a first electronic device 901 (e.g., the electronic devices 101 and 102 of FIG. 1, the first electronic device 220 of FIGS. 2A and 2B, the first electronic device 705 of FIG. 7, the first electronic device 805 of FIG. 8, the first electronic device 1003 of FIG. 10A, the first electronic device 1103 of FIG. 11, the first electronic device 1203 of FIG. 12, the first electronic device 1303 of FIG. 13, the first electronic device 1901 of FIG. 19, and/or the first electronic device 2001 of FIG. 20) that outputs a content over a first display (e.g., the first display 225 of FIGS. 2A and 2B).

According to an embodiment, as a power control module (e.g., the power control module 210 of FIGS. 2A and 2B, the power control module 703 of FIG. 7, the power control module 803 of FIG. 8, and/or the power control module 2300 of FIG. 23) activates a low-power setting for the first electronic device 901, the low-power setting may be activated in the first electronic device 901 by any one of or a combination of, for example, a setting to lower backlight of the first display 225 as shown in drawing 910, a setting to lower a content playing quality of a content output from the first display 225 as shown in drawing 920, a setting to activate a power-saving mode of the first electronic device 901 as shown in drawing 930, a setting to activate on/off combinations of a display and a sound by, for example, turning off the first display 225 and turning on the sound, as shown in drawing 940, and a setting to turn off the power of the first electronic device 901 as shown in drawing 950.

For example, when a set value of the backlight is changed from 20 to 12 by the setting to lower the backlight of the first display 225, power consumption of the first electronic device 901 may be saved to 81.27 watts (W) from 109.8 W. For another example, when the set value of the backlight of the first display 225 is changed from 12 to 5, the power consumption of the first electronic device 901 may be saved to 57.51 W from 81.27 W.

In this case, the power control module 210 may support a low-power output change for the first electronic device 901 even within a screen timeout time specified for the first display 225.

FIGS. 10A, 10B and 10C are diagrams illustrating examples of activating a low-power setting for a first electronic device when there is a single effective device in a service area according to an embodiment.

Referring to FIG. 10A, drawing 1001 shows a situation 1001 where there are a TV 1003 which is a first electronic device (e.g., the electronic devices 101 and 102 of FIG. 1, the first electronic device 220 of FIGS. 2A and 2B, the first electronic device 705 of FIG. 7, the first electronic device 805 of FIG. 8, the first electronic device 901 of FIG. 9, the first electronic device 1103 of FIG. 11, the first electronic device 1203 of FIG. 12, the first electronic device 1303 of FIG. 13, the first electronic device 1901 of FIG. 19, and/or the first electronic device 2001 of FIG. 20) and a mobile terminal 1004 which is a single effective device (e.g., the mobile terminal 1104 of FIG. 11, the mobile terminals 1204 and 1206 of FIG. 12, and/or the mobile terminals 1304, 1306, and 1308 of FIG. 13), in a service area (e.g., at home) of a power control module (e.g., the power control module 210 of FIGS. 2A and 2B, the power control module 703 of FIG. 7, the power control module 803 of FIG. 8, and/or the power control module 2300 of FIG. 23).

There may be electronic devices 1003 and 1004 in the service area as shown in drawing 1001, and the electronic devices 1003 and 1004 may be in a wait state for use as shown in drawing 1011. The power control module 210 may determine whether the electronic devices 1003 and 1004 corresponding to users are located within the service area using, for example, global positioning systems (GPS) of a home network and the electronic devices 1003 and 1004.

While a content is playing on the TV 1003 located in the service area as shown in drawing 1012, a processor of the mobile terminal 1004 may be activated as shown in drawing 1013. The power control module 210 may set, as an interested device corresponding to a user 1002, the TV 1003 to which an operation signal according to the content playing is transmitted first among the electronic devices 1003 and 1004 located in the service area.

For example, a time of performing a task, such as, for example, being on SNS or shopping online, in the mobile terminal 1004 while the user 1002 is watching the TV 1003 may last for 5 minutes or more as shown in drawing 1014. In this example, when the duration of use of the mobile terminal 1004 exceeds a preset time (e.g., 3 minutes), the power control module 210 may set the mobile terminal 1004 as the interested device while canceling the setting of the TV 1003 as the interested device.

After canceling the setting of the TV 1003 as the interested device, the power control module 210 may transmit a signal activating the low-power setting to the TV 1003 as shown in drawing 1015 to activate the low-power setting for the TV 1003 as shown in drawing 1016.

Referring to FIG. 10B, there may be electronic devices 1003 and 1004 in the service area as shown in drawing 1001, and the electronic devices 1003 and 1004 may be in a wait state for use as shown in drawing 1021. While in the wait state, a processor of the mobile terminal 1004 may be activated as shown in drawing in 1023 while a content is playing on the TV 1003 located in the service area as shown in drawing 1022. The power control module 210 may set, as an interested device corresponding to the user 1002, the TV 1003 that is activated first among the electronic devices 1003 and 1004 in the service area.

While watching the TV 1003, the user 1002 may perform a task that consumes a great amount of battery, such as playing a game, on the mobile terminal 1004 as shown in drawing 1024. In this case, when a power consumption amount of playing the game in the mobile terminal 1004 greatly increases compared to a preset reference or a power consumption amount of the TV 1003, the power control module 210 may set the mobile terminal 1004 as the interested device while canceling the setting of the TV 1003 as the interested device.

After canceling the setting of the TV 1003 as the interested device, the power control module 210 may transmit a low-power setting activation signal that activates the low-power setting to the TV 1003 as shown in drawing 1025 to activate the low-power setting for the TV 1003 as shown in drawing 1026.

In addition, referring to FIG. 10C, there may be electronic devices 1003 and 1004 in the service area as shown in drawing 1001, and the electronic devices 1003 and 1004 may be in a wait state for use as shown in drawing 1031. While in the wait state, a processor of the mobile terminal 1004 may be activated as shown in drawing in 1033 while a content is playing on the TV 1003 located in the service area as shown in drawing 1032. The power control module 210 may set, as the interested device corresponding to the user 1002, the TV 1003 that is activated first among the electronic devices 1003 and 1004 in the service area.

While watching the TV 1003, the user 1002 may perform a task (e.g., playing a video content (e.g., YouTube®)) of outputting a content on the mobile terminal 1004 using the same modality (e.g., visual modality and auditory modality) as a content provided by the TV 1003, as shown in drawing 1034. When the TV 1003 and the mobile terminal 1004 provide the same type of a content (e.g., a video content), the user 1002 may concentrate mainly on any one content, and thus the power control module 210 may set, as the interested device of the user 1002, the mobile terminal 1004 that outputs the content playing later than the TV 1003 while canceling the setting of the TV 1003 as the interested device.

After canceling the setting of the TV 1003 as the interested device, the power control module 210 may transmit a low-power setting activation signal that activates the low-power setting to the TV 1003 as shown in drawing 1035 to activate the low-power setting for the TV 1003 as shown in drawing 1036.

FIG. 11 is a diagram illustrating a low-power control method performed when there is a single effective device in a service area according to an embodiment. Referring to FIG. 11, drawing 1101 shows a situation where a TV 1103 which is a first electronic device (e.g., the electronic devices 101 and 102 of FIG. 1, the first electronic device 220 of FIGS. 2A and 2B, the first electronic device 705 of FIG. 7, the first electronic device 805 of FIG. 8, the first electronic device 901 of FIG. 9, the first electronic device 1003 of FIG. 10A, the first electronic device 1203 of FIG. 12, the first electronic device 1303 of FIG. 13, the first electronic device 1901 of FIG. 19, and/or the first electronic device 2001 of FIG. 20) and a mobile terminal 1104 which is a single effective device (e.g., the mobile terminal 1004 of FIG. 10A, the mobile terminal 1204 or 1206 of FIG. 12, and/or the mobile terminal 1304, 1306, or 1308 of FIG. 13) are present in the same space in a service area (e.g., at home) of a power control module (e.g., the power control module 210 of FIGS. 2A and 2B, the power control module 703 of FIG. 7, the power control module 803 of FIG. 8, and/or the power control module 2300 of FIG. 23); and drawing 1105 shows a situation where the TV 1103 which is the first electronic device and the mobile terminal 1104 which is the single effective device are present in different spaces.

As shown in drawings 1101 and 1105, when there is one mobile terminal 1104 in the service area, the power control module 210 may control a low-power setting of the TV 1103 only by an active state of the mobile terminal 1104.

For example, when an interest level of a user increases while a content is playing on the TV 1103 by, for example, a continued time of interaction with the mobile terminal 1104 or an increasing power consumption amount, as shown in drawing 1110, the power control module 210 may activate ultrawide band (UWB) communication between the TV 1103 and the mobile terminal 1104 as shown in drawing 1120.

The UWB communication may be performed using impulse waves instead of sinusoidal waves. Through the UWB communication, electromagnetic waves may be exchanged between transmitting/receiving ends, and a distance may be obtained by dividing a departure/arrival time by the speed of light. For example, through the UWB communication, the distance may be obtained using a time difference of arrival (TDoA) and/or two-way ranging (TWR), which is a time used for radio waves to arrive from the transmitting end to the receiving end, or from the receiving end to the transmitting end. In this case, clocks of the transmitting end and the receiving end may need to be as synchronized as possible.

However, measuring the distance through the UWB communication may not provide an indication of directivity. Therefore, a direction may be determined by employing two antennas included in each device. When the two antennas are used, there may be a time difference between the antenna closer to the receiving end and the antenna far from the receiving end, and the direction between the two corresponding devices may be determined from a triangle formed as the distance is measured based on the time difference.

When the distance and direction between the TV 1103 and the mobile terminal 1104 are verified through the UWB communication, the power control module 210 may estimate the distance between the TV 1103 and the mobile terminal 1104 based on the verified distance and direction, as shown in drawing 1130.

The power control module 210 may estimate an angle between the TV 1103 and the mobile terminal 1104 based on the estimated distance and direction between the TV 1103 and the mobile terminal 1104, as shown in drawing 1140, and may thereby calculate a viewing angle of a user 1102 with respect to the mobile terminal 1104. For example, the power control module 210 may estimate the angle using, for example, an angle of arrival (AOA).

For example, there may be a difference in the time at which signals arrive at each of electronic devices, and a phase difference may thus occur between the signals input to the respective electronic devices. The mobile terminal 1104 may calculate a direction (angle) in which the TV 1103 is located using such a phase difference. The mobile terminal 1104 may include, for example, three antennas, and may detect a highly precise position including a direction and an angle between UWB devices by a three-dimensional (3D) AOA technique.

For example, when a viewing angle of the user 1102 matches the TV 1103 as shown in drawing 1150, the power control module 210 may determine that the user 1102 concentrates on the mobile terminal 1104 while watching the TV 1103 and determine the mobile terminal 1104 as the interested device, and may thereby activate a low-power setting for the TV 1103. In this example, that “the viewing angle of the user 1102 matches the TV 1103” may be construed that a display of the TV 1103 is located within the viewing angle of the user 1102 and/or a content playing on the display of the TV 1103 is in a viewable range of angle of the user 1102.

When the viewing angle of the user 1102 does not match the TV 1103 as shown in drawing 1160, the power control module 210 may determine that the user 1102 is not watching the TV 1103 and activate the low-power setting for the TV 1103.

As shown in drawings 1101 and 1105, when there is a single effective device in the service area, the power control module 210 may activate the low-power setting for the TV 110, regardless of whether the viewing angle of the user 1102 calculated in the mobile terminal 1104 through the UWB communication between the mobile terminal 1104 and the TV 1103 matches the TV 1103 which is the first electronic device.

FIG. 12 is a diagram illustrating a low-power control method performed when there is a plurality of effective devices in a service area and the effective devices are in different spaces according to an embodiment.

Referring to FIG. 12, drawing 1201 shows a situation where a TV 1203 which is a first electronic device (e.g., the electronic devices 101 and 102 of FIG. 1, the first electronic device 220 of FIGS. 2A and 2B, the first electronic device 705 of FIG. 7, the first electronic device 805 of FIG. 8, the first electronic device 901 of FIG. 9, the first electronic device 1003 of FIG. 10A, the first electronic device 1103 of FIG. 11, the first electronic device 1303 of FIG. 13, the first electronic device 1901 of FIG. 19, and/or the first electronic device 2001 of FIG. 20) and a mobile terminal 1204 which is a first effective device are present in the same space in a service area (e.g., at home) of a power control module (e.g., the power control module 210 of FIGS. 2A and 2B, the power control module 703 of FIG. 7, the power control module 803 of FIG. 8, and/or the power control module 2300 of FIG. 23), and a mobile terminal 1206 which is a second effective device is present in a different space. In this situation, the mobile terminal 1204 may belong to a user 1202, and the mobile terminal 1206 may belong to a user 1205.

For example, as shown in FIG. 12, when there is a plurality of effective devices (e.g., 1204 and 1206) in the service area and a low-power setting for the TV 1203 is controlled only by an active state of the mobile terminal 1206 between the devices 1204 and 1206, the low-power setting for the TV 1203 may be activated even though the other user 1202 is watching the TV 1203, which may cause inconvenience to the other user 1202.

In this case, the power control module 210 may determine whether to reflect the active state of the mobile terminal 1206 in the low-power setting for the TV 1203 through UWB communication between the mobile terminal 1206 and the TV 1203.

For example, as shown in drawing 1210, in the situation where the TV 1203 and the mobile terminal 1206 are in different spaces, an interest level of the user 1205 toward the mobile terminal 1206 may increase more than an interest level of the user 1202 toward the mobile terminal 1204. In this case, the power control module 210 may determine the mobile terminal 1206 as an interested device (or a device of highest interest) from between the mobile terminal 1204 and the mobile terminal 1206.

The power control module 210 may transmit a signal activating the UWB communication between the mobile terminal 1206 determined as the interested device and the TV 1203, as shown in drawing 1220. The power control module 210 may obtain information on a distance and a direction between the mobile terminal 1206 and the TV 1203 calculated through the UWB communication.

The power control module 210 may estimate the distance between the mobile terminal 1206 and the TV 1203 based on the information on the distance and direction between the mobile terminal 1206 and the TV 1203, as shown in drawing 1230.

The power control module 210 may verify a viewing angle of the user 1205 with respect to the mobile terminal 1206 based on the distance, and direction between the mobile terminal 1206 and the TV 1203, as shown in drawing 1240.

When verified that the viewing angle of the user 1205 does not match the TV 1203, the power control module 210 may identify a state of the user 1205 of the mobile terminal 1206, for example, a state in which the user 1205 is not watching the TV 1203, as shown in drawing 1250, and may not reflect the active state of the mobile terminal 1206 which is the interested device in the low-power setting for the TV 1203.

For example, the TV 1203 may be located out of the viewing angle of the user 1205 of the mobile terminal 1206 which is the interested device, and the mobile terminal 1204 adjacent to the TV 1203 may be determined as a device of second highest interest. In this example, the power control module 210 may activate the low-power setting for the TV 1203 based on whether the TV 1203 matches a viewing angle of the user 1202 of the mobile terminal 1204.

FIG. 13 is a diagram illustrating an example of obtaining approval of a user for activation of a low-power setting using an interested device among a plurality of effective devices when there is a plurality of effective devices in a service area according to an embodiment.

Referring to FIG. 13, drawing 1301-1 shows a situation where a TV 1303 which is a first electronic device (e.g., the electronic devices 101 and 102 of FIG. 1, the first electronic device 220 of FIGS. 2A and 2B, the first electronic device 705 of FIG. 7, the first electronic device 805 of FIG. 8, the first electronic device 901 of FIG. 9, the first electronic device 1003 of FIG. 10A, the first electronic device 1103 of FIG. 11, the first electronic device 1203 of FIG. 12, the first electronic device 1901 of FIG. 19, and/or the first electronic device 2001 of FIG. 20), a mobile terminal 1304 which is a first effective device, and a mobile terminal 1306 which is a second effective device are in the same space in a service area (e.g., at home) of a power control module (e.g., the power control module 210 of FIGS. 2A and 2B, the power control module 703 of FIG. 7, the power control module 803 of FIG. 8, and/or the power control module 2300 of FIG. 23); drawing 1301-2 shows a situation where the TV 1303 which is the first electronic device and the mobile terminal 1304 which is the first effective device are in the same space and the mobile terminal 1306 which is the second effective device is in a different space; and drawing 1301-3 shows a situation where the TV 1303 which is the first electronic device and the mobile terminal 1304 which is the first effective device are in the same space, and the mobile terminal 1306 which is the second effective device and a mobile terminal 1308 which is a third effective device are in different spaces, respectively, from the space in which the mobile terminal 1304 which is the first effective device is present.

In the situations shown in drawings 1301-1, 1301-2, and 1301-3, the mobile terminal 1304 may belong to a user 1302, the mobile terminal 1306 may belong to a user 1305, and the mobile terminal 1308 may belong to a user 1307. The power control module 210 may determine whether mobile terminals corresponding to users are in the service area, using a GPS of a home network and each electronic device, for example.

For example, in a situation in which a plurality of effective devices (e.g., 1304, 1306, and/or 1308) in the service area as shown in drawings 1301-1, 1301-2, and 1301-3 are waiting to be used as shown in drawing 1310, one of users (e.g., 1302, 1305, and 1307) may play a content on the TV 1303 as shown in drawing 1320.

In this example, as the user 1302 searches the Internet through the mobile terminal 1304 while the content is playing on the TV 1303, a processor of the mobile terminal 1304 may be activated as shown in drawing 1330.

When duration of an input interaction in the mobile terminal 1304 exceeds a preset time (e.g., 5 minutes) as shown in drawing 1340, the power control module 210 may determine the mobile terminal 1304 as an interested device (or a device of highest interest). The power control module 210 may activate UWB communication between the mobile terminal 1304 determined as the interested device and the TV 1303 to obtain a distance, direction, and angle between the mobile terminal 1304 and the TV 1303, and may thereby determine whether a viewing angle of the user 1302 matches the TV 1303.

When the viewing angle of the user 1302 matches the TV 1303, the power control module 210 may obtain a user approval for activation of the low-power setting for the TV 1303 using the mobile terminal 1304. In this case, for example, the user approval may be obtained as a user selects a button “Execute” included in a pop-up menu (e.g., “Do you want to activate low-power setting for TV?”) on a screen of the mobile terminal 1304 as illustrated in 1350.

As described above, when there are a plurality of effective devices (e.g., 1304, 1306, and/or 1308) in the service area, the power control module 210 may obtain approval for the activation of the low-power setting from the user 1302 of the mobile terminal 1304 which is the interested device before activating the low-power setting for the TV 1303 to allow the user 1302 to reflect needs of another user in the same space and execute the low-power setting.

FIG. 14 is a diagram illustrating an example of adjusting at least one of an intensity or an application range of a low-power setting for a first electronic device based on interest information according to an embodiment. Referring to FIG. 14, drawing 1400 shows how a power control module (e.g., the power control module 210 of FIGS. 2A and 2B, the power control module 703 of FIG. 7, the power control module 803 of FIG. 8, and/or the power control module 2300 of FIG. 23) adjusts an application range of a low-power setting based on an interest level of a user.

The power control module 210 may adjust at least one of an intensity or an application range of a low-power setting for a TV which is a first electronic device (e.g., the electronic devices 101 and 102 of FIG. 1, the first electronic device 220 of FIGS. 2A and 2B, the first electronic device 705 of FIG. 7, the first electronic device 805 of FIG. 8, the first electronic device 901 of FIG. 9, the first electronic device 1003 of FIG. 10A, the first electronic device 1103 of FIG. 11, the first electronic device 1203 of FIG. 12, the first electronic device 1303 of FIG. 13, the first electronic device 1901 of FIG. 19, and/or the first electronic device 2001 of FIG. 20), based on interest information including an interest level of a user corresponding to a mobile terminal which is an interested device.

For example, the power control module 210 may control the intensity of the low-power setting for the TV by differentially determining an interest level of the user according to a task being performed in the mobile terminal and the duration of use of the mobile terminal.

In this example, when the task being performed in the mobile terminal is online shopping or using SNS, the power control module 210 may control the low-power setting for the TV to a “weak power-saving” intensity or intensity “1.” When the task being performed in the mobile terminal is playing a video content, the power control module 210 may control the low-power setting for the TV to a “medium power-saving” intensity or intensity “3.” Alternatively, when the task being performed in the mobile terminal is executing a game app, the power control module 210 may control the low-power setting for the TV to a “strong power-saving” intensity or intensity “5.”

For example, when 5 minutes of the duration of use of the mobile terminal has elapsed, the power control module 210 may control the low-power setting for the TV to be of the “weak power-saving” intensity. When 15 minutes of the duration of use of the mobile terminal has elapsed, the power control module 210 may control the low-power setting to be of the “medium power-saving” intensity. In addition, when 30 minutes of the duration of use of the mobile terminal has elapsed, the power control module 210 may control the low-power setting for the TV to be of the “strong power-saving” intensity.

For example, when the low-power setting is controlled to be of the “weak power-saving” intensity, a backlight setting value of the TV may be adjusted from 20 to 12, or an image quality (resolution) of a content playing on the TV may be adjusted to be lowered by one level from a preset value. When the low-power setting is controlled to be of the “medium power-saving” intensity, the backlight setting value of the TV may be adjusted from 12 to 5, the image quality (resolution) of the content playing on the TV may be adjusted to be lowered two levels from the preset value, or a power-saving mode of the TV may be activated. When the low-power setting is controlled to be of the “strong power-saving” intensity, a display of the TV may be changed to an off state with only the sound playing, or the power of the TV may be turned off.

FIG. 15 is a flowchart illustrating a method of activating a low-power setting based on an interest level of a user according to an embodiment. According to an embodiment, operations may be performed in sequential order, but not be necessarily performed in sequential order. For example, the order of the operations may be changed and at least two of the operations may be performed in parallel.

Referring to FIG. 15, a power control module (e.g., the power control module 210 of FIGS. 2A and 2B, the power control module 703 of FIG. 7, the power control module 803 of FIG. 8, and/or the power control module 2300 of FIG. 23) may activate a low-power setting based on an interest level of a user through operations 1510 to 1560 described below. Operations 1510 to 1560 described below with reference to FIG. 15 may be performed directly by the power control module 210 or by a second electronic device (e.g., the electronic devices 101 and 102 of FIG. 1, the interested device 230 of FIGS. 2A and 2B, the second electronic device 701 of FIG. 7, the second electronic device 801 of FIG. 8, the second electronic device 1004 of FIG. 10A, the second electronic device 1104 of FIG. 11, the second electronic devices 1204 and 1206 of FIG. 12, the second electronic devices 1304, 1306, and 1308 of FIG. 13, the second electronic device 1903 of FIG. 19, and/or the second electronic device 2003 of FIG. 20).

In operation 1510, the power control module 210 may determine whether a power consumption amount of the second electronic device is consumed faster than before by a predetermined or more level. For example, the power control module 210 may determine whether the power consumption amount of the second electronic device is consumed faster than before by the predetermined or more level by retrieving or inquiring power consumption information of the second electronic device through a power management program and comparing the retrieved information and the power consumption amount of the second electronic device.

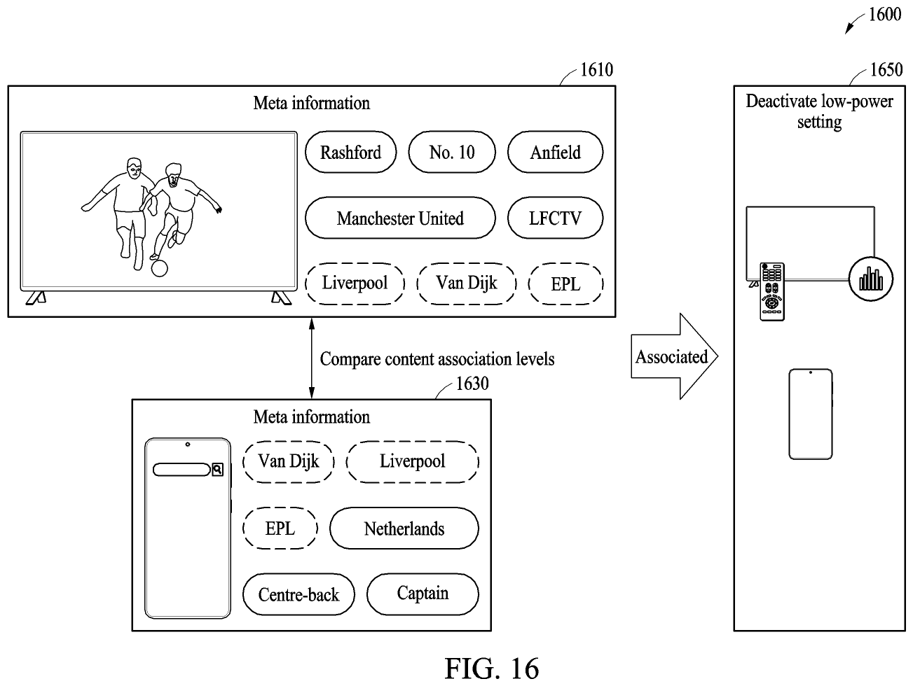

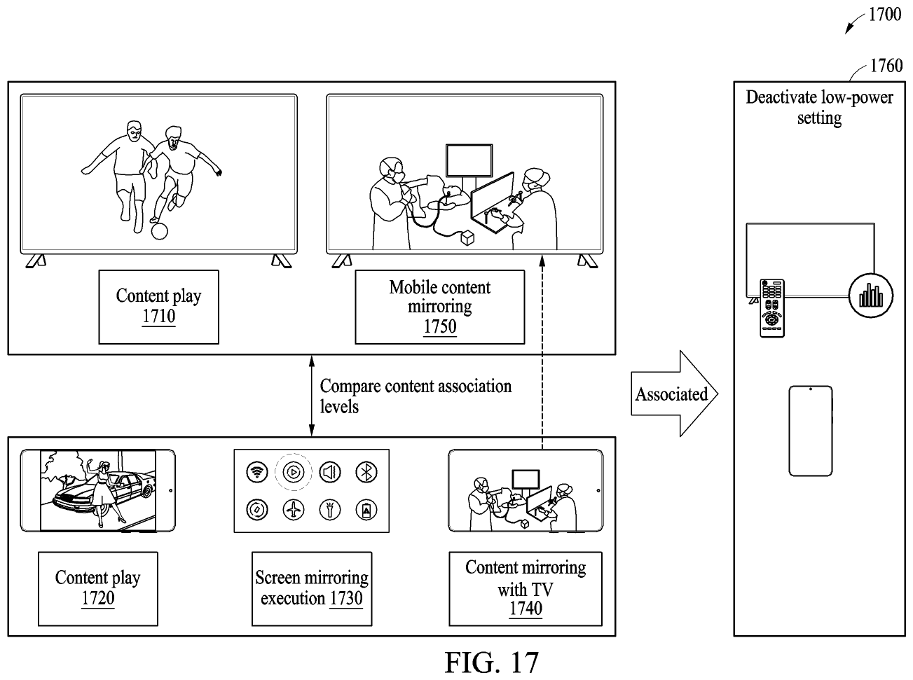

For example, when it is determined in operation 1510 that the power consumption amount of the second electronic device is consumed faster than before by the predetermined or more level, the power control module 210 may determine whether there is an association between a second content displayed on the second electronic device and a first content displayed on a first electronic device in operation 1540. The association may be determined based on a level of association between the second content and the first content described in greater detail below with reference to FIGS. 16 and 17.

When it is determined in operation 1540 that the second content and the first content are associated, the power control module 210 may determine again whether the power consumption amount of the second electronic device is consumed faster than before by the predetermined or more level in operation 1510. When it is determined in operation 1540 that the second content and the first content are not associated, the power control module 210 may determine whether the first electronic device (e.g., a TV P₁) is in an UWB azimuth in operation 1550.

For example, when it is determined that the first electronic device (e.g., the TV P₁) is in the UWB azimuth, the power control module 210 may activate a low-power setting for the first electronic device in operation 1560. When it is determined that the first electronic device (e.g., the TV P₁) is out of the UWB azimuth, the power control module 210 may determine whether the power consumption amount of the second electronic device is consumed faster than before by the predetermined or more level in operation 1510.

When it is determined in operation 1510 that the power consumption amount of the second electronic device is consumed faster than before by the predetermined or more level, the power control module 210 may determine whether a video content is playing on the second electronic device in operation 1520. In this case, whether the video content is playing or not may be determined based on whether a codec service is performed in the second electronic device.

When it is determined in operation 1520 that the video content is playing, the power control module 210 may perform operation 1510 again. In contrast, when it is determined in operation 1520 that the video content is not playing, the power control module 210 may determine whether N minutes of duration of an input interaction occurring in the second electronic device has elapsed in operation 1530. The input interaction may include, for example, a gaze of a user detected by the second electronic device, in addition to a touch input, a remote control input, and a typing input. The duration of the input interaction may be defined differently for each type of the second electronic device and/or each task (e.g., shopping online, using SNS, and playing a game).

When it is determined in operation 1530 that N minutes of the duration of the input interaction has elapsed, the power control module 210 may determine whether the second content displayed on the second electronic device and the first content displayed on the first electronic device are associated in operation 1540 as described above, and may perform operation 1510 or perform operations 1550 and 1560 to activate the low-power setting for the first electronic device.

FIG. 16 is a diagram illustrating an example of determining whether to activate a low-power setting based on a level of association according to an embodiment. Referring to FIG. 16, drawing 1600 shows how a power control module (e.g., the power control module 210 of FIGS. 2A and 2B, the power control module 703 of FIG. 7, the power control module 803 of FIG. 8, and/or the power control module 2300 of FIG. 23) determines whether to activate a low-power setting based on a level of association between a first content displayed on a first electronic device (e.g., the electronic devices 101 and 102 of FIG. 1, the first electronic device 220 of FIGS. 2A and 2B, the first electronic device 705 of FIG. 7, the first electronic device 805 of FIG. 8, the first electronic device 901 of FIG. 9, the first electronic device 1003 of FIG. 10A, the first electronic device 1103 of FIG. 11, the first electronic device 1203 of FIG. 12, the first electronic device 1303 of FIG. 13, the first electronic device 1901 of FIG. 19, and/or the first electronic device 2001 of FIG. 20) and a second content displayed on a second electronic device (e.g., the electronic devices 101 and 102 of FIG. 1, the interested device 230 of FIGS. 2A and 2B, the second electronic device 701 of FIG. 7, the second electronic device 801 of FIG. 8, the second electronic device 1004 of FIG. 10A, the second electronic device 1104 of FIG. 11, the second electronic devices 1204 and 1206 of FIG. 12, the second electronic devices 1304, 1306, and 1308 of FIG. 13, the second electronic device 1903 of FIG. 19, and/or the second electronic device 2003 of FIG. 20) which is determined as an interested device.

For example, meta information 1610 of the first content displayed on the first electronic device and meta information 1630 of the second content displayed on the second electronic device may have a matching or similar portion (e.g., “Van Dijk,” “Liverpool,” and “EPL”).

In this case, the power control module 210 may determine the level of association between the second content and the first content based on, for example, the number and/or ratio of matching portions between the meta information 1610 and the meta information 1630, and may determine whether to activate the low-power setting for the first electronic device based on the determined level of association.

For example, the power control module 210 may determine the level of association as “1” when the number of matching portions between the meta information 1610 and the meta information 1630 is 1, and may determine the level of association as “3” when the number of matching portions between the meta information 1610 and the meta information 1630 is 3. When the number of matching portions between the meta information 1610 and meta information 1630 is 5, the power control module 210 may determine the level of association as “5.”

For example, when the level of association is 3 or greater, the power control module 210 may determine that the second content and the first content are associated and may deactivate the low-power setting for the first electronic device as shown in 1650. When the level of association is less than 3, the power control module 210 may determine that the second content and the first content are not associated and may activate the low-power setting for the first electronic device.

According to an embodiment, the power control module 210 may determine the level of association based on whether the meta information 1610 of the first content matches a keyword input to the second electronic device to activate the low-power setting for the first electronic device.

FIG. 17 is a diagram illustrating an example of determining whether to activate a low-power setting based on a level of association according to another embodiment. Referring to FIG. 17, drawing 1700 shows an example method of determining whether to activate a low-power setting based on a level of association between a first content displayed on a TV which is a first electronic device (e.g., the electronic devices 101 and 102 of FIG. 1, the first electronic device 220 of FIGS. 2A and 2B, the first electronic device 705 of FIG. 7, the first electronic device 805 of FIG. 8, the first electronic device 901 of FIG. 9, the first electronic device 1003 of FIG. 10A, the first electronic device 1103 of FIG. 11, the first electronic device 1203 of FIG. 12, the first electronic device 1303 of FIG. 13, the first electronic device 1901 of FIG. 19, and/or the first electronic device 2001 of FIG. 20) and a second content displayed on a mobile terminal or a tablet which is determined as an interested device.

For example, after the first content is playing on the TV as shown in drawing 1710, the second content may be playing on the tablet as shown in drawing 1720. In this case, when screen mirroring is executed on the tablet as shown in drawing 1730, the second content shown in drawing 1740 may be mirrored onto the TV as shown in drawing 1750.

When the second content displayed on the tablet is playing the same on the TV through screen mirroring, the power control module 210 may determine a high level of association (e.g., 5) between the first content and the second content and deactivate the low-power setting for the TV as shown in drawing 1760.

FIGS. 18A and 18B are diagrams illustrating an example of canceling a low-power setting for a first electronic device in response to a predefined user input occurring in the first electronic device when the low-power setting for the first electronic device is activated according to an embodiment.

Referring to FIG. 18A, in a situation where a low-power setting is activated for a first electronic device (e.g., the electronic devices 101 and 102 of FIG. 1, the first electronic device 220 of FIGS. 2A and 2B, the first electronic device 705 of FIG. 7, the first electronic device 805 of FIG. 8, the first electronic device 901 of FIG. 9, the first electronic device 1003 of FIG. 10A, the first electronic device 1103 of FIG. 11, the first electronic device 1203 of FIG. 12, the first electronic device 1303 of FIG. 13, the first electronic device 1901 of FIG. 19, and/or the first electronic device 2001 of FIG. 20), a remote control input providing an instruction to change a channel and/or volume of first electronic device may occur as shown in drawing 1810.

When the low-power setting for the first electronic device is activated, the occurrence of such an input controlling the first electronic device may indicate that an interest of a user toward the first electronic device has changed (or increased), and thus the power control module 210 may deactivate the low-power setting for the first electronic device as shown in drawing 1820.

Referring to FIG. 18B, in a situation where the lower-power setting for the first electronic device (e.g., a TV) is activated, a remote control input selecting a power-saving mode cancel button of the first electronic device may occur as shown in drawing 1830.

The occurrence of the input selecting the power-saving mode cancel button may indicate a reflection of the intent of the user to cancel the low-power setting activated for the first electronic device. Thus, the power control module 210 may deactivate the low-power setting for the first electronic device as shown in drawing 1840.

FIG. 19 is a diagram illustrating an example of canceling an activated low-power setting according to an embodiment. Referring to FIG. 19, in a situation where a low-power setting for a first electronic device 1901 (e.g., the electronic devices 101 and 102 of FIG. 1, the first electronic device 220 of FIGS. 2A and 2B, the first electronic device 705 of FIG. 7, the first electronic device 805 of FIG. 8, the first electronic device 901 of FIG. 9, the first electronic device 1003 of FIG. 10A, the first electronic device 1103 of FIG. 11, the first electronic device 1203 of FIG. 12, the first electronic device 1303 of FIG. 13, and/or the first electronic device 2001 of FIG. 20) is activated as shown in drawing 1910, a processor (e.g., the processor 120 of FIG. 1) of a second electronic device 1903 (e.g., the electronic devices 101 and 102 of FIG. 1, the interested device 230 of FIGS. 2A and 2B, the second electronic device 701 of FIG. 7, the second electronic device 801 of FIG. 8, the second electronic device 1004 of FIG. 10A, the second electronic device 1104 of FIG. 11, the second electronic device 1206 of FIG. 12, the second electronic device 1304 of FIG. 13, and/or the second electronic device 2003 of FIG. 20) which is determined as an interested device may be in operation.

In this situation, when a screen of the second electronic device 1903 is turned off and processing is suspended, the second electronic device 1903 may be changed to an inactive state as shown in drawing 1920. In this case, a power control module (e.g., the power control module 210 of FIGS. 2A and 2B, the power control module 703 of FIG. 7, the power control module 803 of FIG. 8, and/or the power control module 2300 of FIG. 23) may transmit a low-power setting deactivation signal for deactivating the low-power setting to the first electronic device 1901 as shown in drawing 1930.

When receiving the low-power setting deactivation signal from the power control module 210, the first electronic device 1901 may deactivate the low-power setting as shown in drawing 1940.

FIG. 20 is a diagram illustrating another example of canceling an activated low-power setting according to an embodiment. Referring to FIG. 20, in a situation where a low-power setting for a first electronic device 2001 (e.g., the electronic devices 101 and 102 of FIG. 1, the first electronic device 220 of FIGS. 2A and 2B, the first electronic device 705 of FIG. 7, the first electronic device 805 of FIG. 8, the first electronic device 901 of FIG. 9, the first electronic device 1003 of FIG. 10A, the first electronic device 1103 of FIG. 11, the first electronic device 1203 of FIG. 12, the first electronic device 1303 of FIG. 13, and/or the first electronic device 1901 of FIG. 19) is activated, a second electronic device 2003 (e.g., the electronic devices 101 and 102 of FIG. 1, the interested device 230 of FIGS. 2A and 2B, the second electronic device 701 of FIG. 7, the second electronic device 801 of FIG. 8, the second electronic device 1004 of FIG. 10A, the second electronic device 1104 of FIG. 11, the second electronic device 1206 of FIG. 12, the second electronic device 1304 of FIG. 13, and/or the second electronic device 1903 of FIG. 19) which is determined as an interested device may track an eye gaze of a user 2005 (e.g., the user 1002 of FIG. 10A, the user 1102 of FIG. 11, the user 1205 of FIG. 12, and/or the user 1302 of FIG. 13) as shown in drawing 2010 and may detect a departure of the eye gaze of the user 2005 from the second electronic device 2003 during the tracking as shown in drawing 2020. In this case, when it is detected that a preset time (e.g., 1 minute or 40 seconds) of the gaze departure of the user 2005 has elapsed as shown in drawing 2030, a power control module (e.g., the power control module 210 of FIGS. 2A and 2B, the power control module 703 of FIG. 7, the power control module 803 of FIG. 8, and/or the power control module 2300 of FIG. 23) may deactivate the low-power setting activated for the first electronic device 2001 as shown in 2040.

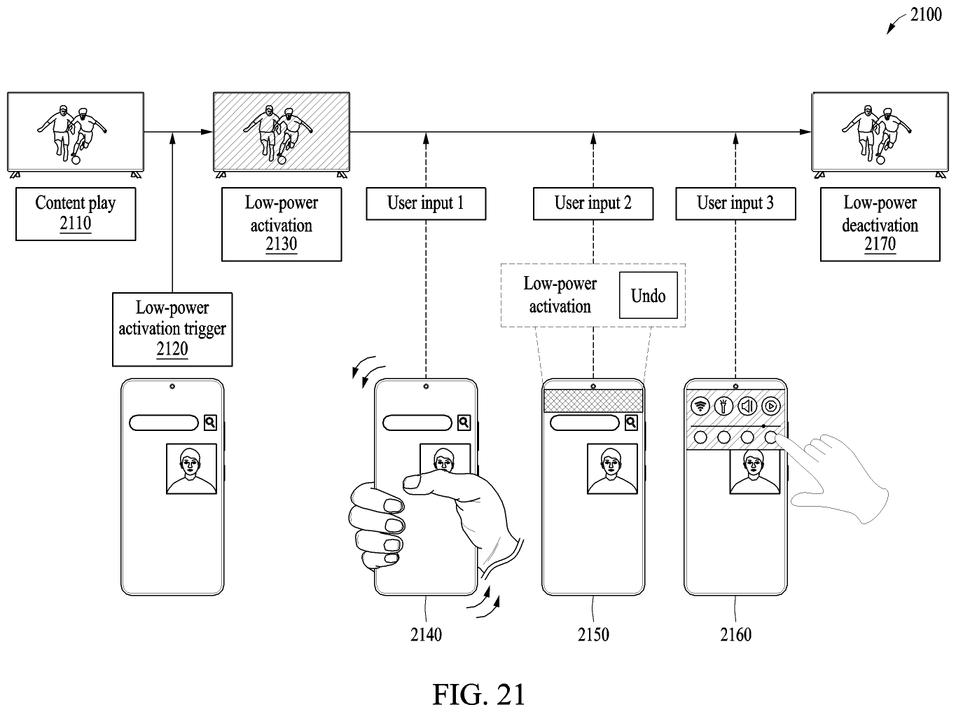

FIG. 21 is a diagram illustrating an example of canceling an activated low-power setting according to an embodiment. Referring to FIG. 21, there may be situations where a low-power setting for a TV which is a first electronic device (e.g., the electronic devices 101 and 102 of FIG. 1, the first electronic device 220 of FIGS. 2A and 2B, the first electronic device 705 of FIG. 7, the first electronic device 805 of FIG. 8, the first electronic device 901 of FIG. 9, the first electronic device 1003 of FIG. 10A, the first electronic device 1103 of FIG. 11, the first electronic device 1203 of FIG. 12, the first electronic device 1303 of FIG. 13, the first electronic device 1901 of FIG. 19, and/or the first electronic device 2001 of FIG. 20) is deactivated based on an occurrence of a user interaction predefined by applying thereto an intent of a user to activate the low-power setting in a mobile terminal which is an interested device.

For example, when an input interaction for an Internet search continuously occurs in the mobile terminal while a content is playing on the TV as shown in drawing 2110, the low-power setting for the TV may be triggered as shown in drawing 2120, and the low-power setting for the TV may be activated by a power control module (e.g., the power control module 210 of FIGS. 2A and 2B, the power control module 703 of FIG. 7, the power control module 803 of FIG. 8, and/or the power control module 2300 of FIG. 23) as shown in drawing 2130.

In this case, as a user input predefined to deactivate the low-power setting occurs, the low-power setting activated for the TV may be deactivated. The user input predefined to deactivate the activated low-power setting from the mobile terminal may include, for example, an input shaking the mobile terminal as shown in drawing 2140, an input selecting a button that is displayed on a pop-up message window and requests a change from the low-power setting to an inactive state as shown in drawing 2150, and/or an input selecting a “low-power setting cancel” button from a key panel of the mobile terminal as shown in drawing 2160, but examples of which are not limited thereto.

When the predefined user input described above occurs, the power control module 210 may deactivate the low-power setting for the TV by canceling the low-power setting for the TV as shown in drawing 2170.

FIG. 22 is a flowchart illustrating an example method of operating a second electronic device according to an embodiment. According to an embodiment, operations may be performed in sequential order, but not be necessarily performed in sequential order. For example, the order of the operations may be changed and at least two of the operations may be performed in parallel.

Referring to FIG. 22, a second electronic device (e.g., the electronic devices 101 and 102 of FIG. 1, the interested device 230 of FIGS. 2A and 2B, the second electronic device 701 of FIG. 7, the second electronic device 801 of FIG. 8, the second electronic device 1004 of FIG. 10A, the second electronic device 1104 of FIG. 11, the second electronic devices 1204 and 1206 of FIG. 12, the second electronic devices 1304, 1306, and 1308 of FIG. 13, the second electronic device 1903 of FIG. 19, and/or the second electronic device 2003 of FIG. 20) may be any one of one or more second electronic devices included in a service area in which electronic devices are registered in advance, and may transmit interest information through operations 2210 to 2230 described below.

In operation 2210, the second electronic device may determine information on at least one of duration of an input interaction of at least one of a touch input, a remote control input, a typing input (occurring in the second electronic device), or a gaze of a user detected by the second electronic device; a power consumption amount of a task performed by the second electronic device; or a type of a content plying on the second electronic device.

In operation 2220, the second electronic device may determine an interest level of the user toward the second electronic device based on the determined information.

In operation 2230, the second electronic device may transmit interest information including the interest level to a power control module.

The second electronic device may calculate a viewing angle of the user with respect to the second electronic device and transmit the calculated viewing angle to the power control device, through the following operations.

As the second electronic device is determined as the interested device based on the interest information transmitted to the power control module, the second electronic device may perform UWB communication with a first electronic device. Through UWB communication, the second electronic device may estimate a distance, direction, and angle between the first electronic device and the second electronic device. The second electronic device may calculate the viewing angle of the user with respect to the second electronic device based on the distance, direction, and angle between the first electronic device and the second electronic device. For a more detailed description of how the second electronic device estimates the distance, direction, and angle between the first electronic device and the second electronic device, reference may be made to what has been described above with reference to FIG. 11.

FIG. 23 is a block diagram illustrating an example configuration of a power control module according to an embodiment. Referring to FIG. 23, according to an embodiment, a power control module 2300 (e.g., the power control module 210 of FIGS. 2A and 2B, the power control module 703 of FIG. 7, and/or the power control module 803 of FIG. 8) may include a communication interface (e.g., including communication circuitry) 2310 (e.g., the communication module 190 of FIG. 1), a processor (e.g., including processing circuitry) 2330 (e.g., the processor 120 of FIG. 1), and a memory 2350 (e.g., the memory 130 of FIG. 1). The communication interface 2310, the processor 2330, and the memory 2350 may be connected through a communication bus 2305.

The power control module 2300 may perform low-power control on electronic devices in a service area in which the electronic devices are registered in advance. The electronic devices may include, for example, a first electronic device (e.g., the electronic devices 101 and 102 of FIG. 1, the first electronic device 220 of FIGS. 2A and 2B, the first electronic device 705 of FIG. 7, the first electronic device 805 of FIG. 8, the first electronic device 901 of FIG. 9, the first electronic device 1003 of FIG. 10A, the first electronic device 1103 of FIG. 11, the first electronic device 1203 of FIG. 12, the first electronic device 1303 of FIG. 13, the first electronic device 1901 of FIG. 19, and/or the first electronic device 2001 of FIG. 20) and one or more second electronic devices (e.g., the electronic devices 101 and 102 of FIG. 1, the interested device 230 of FIGS. 2A and 2B, the second electronic device 701 of FIG. 7, the second electronic device 801 of FIG. 8, the second electronic device 1004 of FIG. 10A, the second electronic device 1104 of FIG. 11, the second electronic devices 1204 and 1206 of FIG. 12, the second electronic devices 1304, 1306, and 1308 of FIG. 13, the second electronic device 1903 of FIG. 19, and/or the second electronic device 2003 of FIG. 20), but examples of which are not limited thereto. The power control module 2300 may be included in, for example, a hub or a cloud server for integrated management of a smart home, or may be included in a second electronic device. Alternatively, the power control module 2300 may be the hub, the cloud server, or the second electronic device itself, but is not limited thereto.

The communication interface 2310 may include various communication circuitry and receive an operation signal of the first electronic device that outputs a content over a first display thereof.

In response to the operation signal being received from the communication interface 2310, the processor 2330, which may include various processing circuitry, may determine an effective device located in the service area from among the second electronic devices. The processor 2330 may obtain interest information including an interest level of a user corresponding to the effective device. The processor 2330 may obtain the interest information by determining the interest information by itself or by receiving the interest information determined in the effective device.

The processor 2330 may activate a low-power setting for the first electronic device based on the interest information.

The memory 2350 may store the interest information obtained by the processor 2330.

In addition, the processor 2330 may perform at least one of the methods described above with reference to FIGS. 1 to 22 or an operation corresponding to the at least one method. The processor 2330 may be a hardware-implemented electronic device having a physically structured circuit to execute desired operations. The desired operations may include, for example, code or instructions included in a program. The power control device 2300 implemented in the form of hardware may include, for example, a microprocessor, a central processing unit (CPU), a graphics processing unit (GPU), a processor core, a multi-core processor, a multiprocessor, an application-specific integrated circuit (ASIC), a field-programmable gate array (FPGA), and a neural processing unit (NPU).

The memory 2350 may store at least one program. The memory 2350 may also store various sets of information generated in a processing process of the processor 2330. The memory 2350 may also store various sets of data and programs. The memory 2350 may be a volatile memory (e.g., the volatile memory 132 of FIG. 1) or a non-volatile memory (e.g., the non-volatile memory 134 of FIG. 1). The memory 2350 may include a high-capacity storage medium such as a hard disk to store various sets of data.

According to an example embodiment, a low-power control method performed in a service area of a power control module (e.g., 210, 703, 803, and 2300) in which electronic devices including a first electronic device (e.g., 101, 102, 220, 705, 805, 901, 1003, 1103, 1203, 1303, 1901, and 2001) and one or more second electronic devices (e.g., 101, 102, 230, 701, 801, 1004, 1104, 1204, 1206, 1304, 1306, 1308, 1903, and 2003) are registered, the low-power control method may include: in response to receiving an operation signal of the first electronic device (e.g., 101, 102, 220, 705, 805, 901, 1003, 1103, 1203, 1303, 1901, and 2001) outputting a content over a first display (e.g., 225), determining an effective device (e.g., 1004, 1104, 1204, 1206, 1304, 1306, and 1308) located in the service area from among the second electronic devices (e.g., 101, 102, 230, 701, 801, 1004, 1104, 1204, 1206, 1304, 1306, 1308, 1903, and 2003); obtaining interest information including an interest level corresponding to the effective device (e.g., 1004, 1104, 1204, 1206, 1304, 1306, and 1308); and activating a low-power setting for the first electronic device (e.g., 101, 102, 220, 705, 805, 901, 1003, 1103, 1203, 1303, 1901, and 2001) based on the interest information.

According to an example embodiment, the interest level may be determined based on at least one of duration of an input interaction of at least one of a touch input, a remote control input, a typing input, or a gaze; a power consumption amount of a task performed in the effective device (e.g., 1004, 1104, 1204, 1206, 1304, 1306, and 1308); or a type of a content playing on the effective device (e.g., 1004, 1104, 1204, 1206, 1304, 1306, and 1308). The touch input, the remote control input, and the typing input may occur in the effective device (e.g., 1004, 1104, 1204, 1206, 1304, 1306, and 1308), and the gaze may be detected by the effective device (e.g., 1004, 1104, 1204, 1206, 1304, 1306, and 1308).

According to an example embodiment, the determining of the effective device (e.g., 1004, 1104, 1204, 1206, 1304, 1306, and 1308) may include detecting the effective device (e.g., 1004, 1104, 1204, 1206, 1304, 1306, and 1308) in which an activity change occurs in the service area from among the second electronic devices (e.g., 101, 102, 230, 701, 801, 1004, 1104, 1204, 1206, 1304, 1306, 1308, 1903, and 2003).

According to an example embodiment, the determining of the effective device (e.g., 1004, 1104, 1204, 1206, 1304, 1306, and 1308) may further include: detecting a number of effective devices (e.g., 1004, 1104, 1204, 1206, 1304, 1306, and 1308) in which the activity change occurs in the service area among the second electronic devices (e.g., 101, 102, 230, 701, 801, 1004, 1104, 1204, 1206, 1304, 1306, 1308, 1903, and 2003); and determining an interested device corresponding to a user (e.g., 1002, 1102, 1205, 1302, and 2005) based on the detected number of effective devices (e.g., 1004, 1104, 1204, 1206, 1304, 1306, and 1308).

According to an example embodiment, the determining the interested device based on the detected number of effective devices (e.g., 1004, 1104, 1204, 1206, 1304, 1306, and 1308) may include: based on there being a single effective device (e.g., 1004, 1104, 1204, 1206, 1304, 1306, and 1308), determining the effective device (e.g., 1004, 1104, 1204, 1206, 1304, 1306, and 1308) as the interested device corresponding to the user (e.g., 1002, 1102, 1205, 1302, and 2005); and based on there being a plurality of effective devices (e.g., 1004, 1104, 1204, 1206, 1304, 1306, and 1308), determining any one among the effective devices (e.g., 1004, 1104, 1204, 1206, 1304, 1306, and 1308) as the interested device based on an interest level corresponding to each of the effective devices (e.g., 1004, 1104, 1204, 1206, 1304, 1306, and 1308).

According to an example embodiment, the activating of the low-power setting may include: based on there being a single effective device (e.g., 1004, 1104, 1204, 1206, 1304, 1306, and 1308), activating the low-power setting for the first electronic device (e.g., 101, 102, 220, 705, 805, 901, 1003, 1103, 1203, 1303, 1901, and 2001) regardless of whether a viewing angle calculated by the interested device through communication between the interested device and the first electronic device (e.g., 101, 102, 220, 705, 805, 901, 1003, 1103, 1203, 1303, 1901, and 2001) matches the first electronic device (e.g., 101, 102, 220, 705, 805, 901, 1003, 1103, 1203, 1303, 1901, and 2001).

According to an example embodiment, the activating of the low-power setting may include: based on there being a plurality of effective devices (e.g., 1004, 1104, 1204, 1206, 1304, 1306, and 1308), activating the low-power setting for the first electronic device (e.g., 101, 102, 220, 705, 805, 901, 1003, 1103, 1203, 1303, 1901, and 2001) based on whether the viewing angle of the user (e.g., 1002, 1102, 1205, 1302, and 2005) calculated by the interested device through communication between the interested device and the first electronic device (e.g., 101, 102, 220, 705, 805, 901, 1003, 1103, 1203, 1303, 1901, and 2001) matches the first electronic device (e.g., 101, 102, 220, 705, 805, 901, 1003, 1103, 1203, 1303, 1901, and 2001).

According to an example embodiment, the activating of the low-power setting may include: before activating the low-power setting for the first electronic device (e.g., 101, 102, 220, 705, 805, 901, 1003, 1103, 1203, 1303, 1901, and 2001), obtaining approval of the user (e.g., 1002, 1102, 1205, 1302, and 2005) of the interested device for the activation of the low-power setting.

According to an example embodiment, the activating of the low-power setting may include: activating the low-power setting by any one of or a combination of a setting to lower backlight of the first display (e.g., 225), a setting to lower a content playing quality of the content output from the first display (e.g., 225), a setting to lower a sound of the first electronic device (e.g., 101, 102, 220, 705, 805, 901, 1003, 1103, 1203, 1303, 1901, and 2001), a setting to activate a power-saving mode of the first electronic device (e.g., 101, 102, 220, 705, 805, 901, 1003, 1103, 1203, 1303, 1901, and 2001), and a setting to turn off the power of the first electronic device (e.g., 101, 102, 220, 705, 805, 901, 1003, 1103, 1203, 1303, 1901, and 2001).

The activating of the low-power setting according to an example embodiment may include activating the low-power setting for the first electronic device (e.g., 101, 102, 220, 705, 805, 901, 1003, 1103, 1203, 1303, 1901, and 2001) regardless of whether a screen timeout time specified for the first display (e.g., 225) has elapsed.

The activating of the low-power setting according to an example embodiment may include adjusting at least one of an intensity and an application range of the low-power setting for the first electronic device (e.g., 101, 102, 220, 705, 805, 901, 1003, 1103, 1203, 1303, 1901, and 2001) based on the interest information.

The activating of the low-power setting according to an example embodiment may include: determining a level of association between a second content displayed on the interested device and a first content displayed on the first electronic device (e.g., 101, 102, 220, 705, 805, 901, 1003, 1103, 1203, 1303, 1901, and 2001); and determining whether to activate the low-power setting for the first electronic device (e.g., 101, 102, 220, 705, 805, 901, 1003, 1103, 1203, 1303, 1901, and 2001) based on the determined level of association.

The determining of the level of association according to an example embodiment may include determining the level of association based on at least one of whether meta information of the first content matches a keyword input to the interested device, similarity between the meta information of the first content and meta information of the second content, or whether the second content is playing the same in the first electronic device (e.g., 101, 102, 220, 705, 805, 901, 1003, 1103, 1203, 1303, 1901, and 2001) by screen mirroring.

The activating of the low-power setting according to an example embodiment may include: activating the low-power setting for the first electronic device (e.g., 101, 102, 220, 705, 805, 901, 1003, 1103, 1203, 1303, 1901, and 2001) based on whether a user interaction predefined by applying an intent of the user (e.g., 1002, 1102, 1205, 1302, and 2005) to activate the low-power setting occurs in the interested device.

The low-power control method according to an example embodiment may further include: based on the low-power setting being activated in the first electronic device (e.g., 101, 102, 220, 705, 805, 901, 1003, 1103, 1203, 1303, 1901, and 2001), deactivating the low-power setting activated for the first electronic device (e.g., 101, 102, 220, 705, 805, 901, 1003, 1103, 1203, 1303, 1901, and 2001) based on whether a specified input occurs in any one of the first electronic device (e.g., 101, 102, 220, 705, 805, 901, 1003, 1103, 1203, 1303, 1901, and 2001) and the interested device.

According to an example embodiment, the specified input may include at least one of a remote control input instructing at least one of a channel change, a volume change, or a power-saving mode cancel button of the first electronic device (e.g., 101, 102, 220, 705, 805, 901, 1003, 1103, 1203, 1303, 1901, and 2001); an input that occurs in the interested device and requests a change of the activated low-power setting to an inactive state; or a departure of the gaze detected for a specified or more time.

According to an example embodiment, a low-power control method of a second electronic device (e.g., 101, 102, 230, 701, 801, 1004, 1104, 1204, 1206, 1304, 1306, 1308, 1903, and 2003) in a service area in which electronic devices including a first electronic device (e.g., 101, 102, 220, 705, 805, 901, 1003, 1103, 1203, 1303, 1901, and 2001) and one or more second electronic devices (e.g., 101, 102, 230, 701, 801, 1004, 1104, 1204, 1206, 1304, 1306, 1308, 1903, and 2003) are registered, the low-power control method may include: detecting information of at least one of duration of an input interaction of at least one of a touch input, a remote control input, a typing input, or a gaze; a power consumption amount of a task performed in the second electronic device (e.g., 101, 102, 230, 701, 801, 1004, 1104, 1204, 1206, 1304, 1306, 1308, 1903, and 2003); or a type of a content playing on the second electronic device (e.g., 101, 102, 230, 701, 801, 1004, 1104, 1204, 1206, 1304, 1306, 1308, 1903, and 2003), in which the touch input, the remote control input, and the typing input may occur in the second electronic device (e.g., 101, 102, 230, 701, 801, 1004, 1104, 1204, 1206, 1304, 1306, 1308, 1903, and 2003), and the gaze may be detected by the second electronic device (e.g., 101, 102, 230, 701, 801, 1004, 1104, 1204, 1206, 1304, 1306, 1308, 1903, and 2003); determining an interest level corresponding to the second electronic device (e.g., 101, 102, 230, 701, 801, 1004, 1104, 1204, 1206, 1304, 1306, 1308, 1903, and 2003) based on the determined information; and transmitting interest information including the interest level.

According to an example embodiment, an operation method of the second electronic device (e.g., 101, 102, 230, 701, 801, 1004, 1104, 1204, 1206, 1304, 1306, 1308, 1903, and 2003) may further include: as the second electronic device (e.g., 101, 102, 230, 701, 801, 1004, 1104, 1204, 1206, 1304, 1306, 1308, 1903, and 2003) is determined as an interested device based on the interest information, performing UWB communication with the first electronic device (e.g., 101, 102, 220, 705, 805, 901, 1003, 1103, 1203, 1303, 1901, and 2001); estimating a distance, direction, and angle between the first electronic device (e.g., 101, 102, 220, 705, 805, 901, 1003, 1103, 1203, 1303, 1901, and 2001) and the second electronic device (e.g., 101, 102, 230, 701, 801, 1004, 1104, 1204, 1206, 1304, 1306, 1308, 1903, and 2003) through the UWB communication; calculating a viewing angle with respect to the second electronic device (e.g., 101, 102, 230, 701, 801, 1004, 1104, 1204, 1206, 1304, 1306, 1308, 1903, and 2003) based on the distance, direction, and angle between the first electronic device (e.g., 101, 102, 220, 705, 805, 901, 1003, 1103, 1203, 1303, 1901, and 2001) and the second electronic device (e.g., 101, 102, 230, 701, 801, 1004, 1104, 1204, 1206, 1304, 1306, 1308, 1903, and 2003); and transmitting the viewing angle.

According to an example embodiment, a power control module (e.g., 210, 703, 803, and 2300) for low-power control of electronic devices including a first electronic device (e.g., 101, 102, 220, 705, 805, 901, 1003, 1103, 1203, 1303, 1901, and 2001) and one or more second electronic devices (e.g., 101, 102, 230, 701, 801, 1004, 1104, 1204, 1206, 1304, 1306, 1308, 1903, and 2003) in a service area in which the electronic devices are registered, the power control module (e.g., 210, 703, 803, and 2300) may include: a communication interface (e.g., 190 and 2310) comprising circuitry configured to receive an operation signal of the first electronic device (e.g., 101, 102, 220, 705, 805, 901, 1003, 1103, 1203, 1303, 1901, and 2001) outputting a content over a first display (e.g., 225); a processor (e.g., 120 and 2330) configured to: determine an effective device (e.g., 1004, 1104, 1204, 1206, 1304, 1306, and 1308) located in the service area from among the second electronic devices (e.g., 101, 102, 230, 701, 801, 1004, 1104, 1204, 1206, 1304, 1306, 1308, 1903, and 2003) in response to reception of the operation signal, obtain interest information including an interest level corresponding to the effective device (e.g., 1004, 1104, 1204, 1206, 1304, 1306, and 1308), and activate a low-power setting for the first electronic device (e.g., 101, 102, 220, 705, 805, 901, 1003, 1103, 1203, 1303, 1901, and 2001) based on the interest information; and a memory (e.g., 130 and 2350) configured to store the interest information.

While the disclosure has been illustrated and described with reference to various example embodiments, it will be understood that the various example embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A low-power control method performed in z of a power control module in which electronic devices comprising a first electronic device and one or more second electronic devices are registered, the low-power control method comprising:
determining an effective device located in the service area from among the second electronic devices, in response to receiving an operation signal of the first electronic device outputting a content over a first display;
obtaining interest information including an interest level toward the effective device; and
activating a low-power setting for the first electronic device based on the interest information.

2. The method of claim 1, wherein the interest level is determined based on at least one of duration of an input interaction of at least one of a touch input, a remote control input, or a typing input that occurs in the effective device, or an eye gaze detected by the effective device; a power consumption amount of a task performed in the effective device; or a type of a content playing in the effective device.

3. The method of claim 1, wherein the determining of the effective device comprises:
detecting the effective device in which an activity change occurs in the service area from among the second electronic devices.

4. The method of claim 1, wherein the determining of the effective device comprises:
detecting a number of effective devices in which an activity change occurs in the service area from among the second electronic devices,
the low-power control method further comprising:
determining an interested device corresponding to a user based on the detected number of effective devices.

5. The method of claim 4, wherein the determining of the interested device based on the number of effective devices comprises:
based on there being one effective device, determining the effective device as the interested device corresponding to the user; and
based on there being a plurality of effective devices, determining one of the effective devices as the interested device based on an interest level toward each of the effective devices.

6. The method of claim 4, wherein the activating of the low-power setting comprises:
based on there being one effective device, activating the low-power setting for the first electronic device, irrespective of whether a viewing angle calculated from the interested device through communication between the interested device and the first electronic device matches the first electronic device.

7. The method of claim 4, wherein the activating of the low-power setting comprises:
based on there being a plurality of effective devices, activating the low-power setting for the first electronic device based on whether a viewing angle of the interested device calculated from the interested device through communication between the interested device and the first electronic device matches the first electronic device.

8. The method of claim 7, wherein the activating of the low-power setting comprises:
obtaining approval from the user of the interested device for activation of the low-power setting, before activating the low-power setting for the first electronic device.

9. The method of claim 1, wherein the activating of the low-power setting comprises:
activating the low-power setting by any one of or a combination of a setting to lower backlight of the first display, a setting to lower a content playing quality of the content output from the first display, a setting to lower a sound of the first electronic device, a setting to activate a power-saving mode of the first electronic device, and a setting to turn off power of the first electronic device.

10. The method of claim 1, wherein the activating of the low-power setting comprises:
activating the low-power setting for the first electronic device irrespective of whether a screen timeout time specified for the first display has elapsed.

11. The method of claim 1, wherein the activating of the low-power setting comprises:
adjusting at least one of an intensity or an application range of the low-power setting for the first electronic device based on the interest information.

12. The method of claim 1, wherein the activating of the low-power setting comprises:
determining a level of association between a second content displayed on an interested device and a first content displayed on the first electronic device; and
determining whether to activate the low-power setting for the first electronic device based on the determined level of association.

13. The method of claim 12, wherein the determining of the level of association comprises:
determining the level of association based on at least one of whether meta information of the first content matches a keyword input to the interested device, a similarity between the meta information of the first content and meta information of the second content, or whether the second content is playing on the first electronic device through screen mirroring.

14. The method of claim 1, wherein the activating of the low-power setting comprises:
activating the low-power setting for the first electronic device based on whether a user interaction specified by applying an intent of the user to activate the low-power setting occurs in an interested device.

15. The method of claim 1, further comprising:
based on the low-power setting being activated in the first electronic device, deactivating the activated low-power setting for the first electronic device, based on whether a specified input occurs in any one of the first electronic device and an interested device.

16. The method of claim 15, wherein the specified input comprises at least one of:
a remote control input instructing at least one of a channel change, a volume change, or a power-saving mode cancel button of the first electronic device; or
an input that occurs in the interested device and requests a change of the activated low-power setting to an inactive state, and a departure of an eye gaze for a specified time or more detected by the interested device.

17. A low-power control method of a second electronic device in a service area in which electronic devices comprising a first electronic device and one or more second electronic devices are pre-registered, the low-power control method comprising:
detecting information of at least one of duration of an input interaction of at least one of a touch input, a remote control input, or a typing input that occur in the second electronic device, or an eye gaze detected by the second electronic device; a power consumption amount of a task performed in the second electronic device; or a type of a content playing in the second electronic device;
determining an interest level toward the second electronic device based on the detected information; and
transmitting interest information including the interest level.

18. The method of claim 17, further comprising:
performing ultra-wideband (UWB) communication with the first electronic device, as the second electronic device is determined as an interested device based on the interest information;
estimating a distance, a direction, and an angle between the first electronic device and the second electronic device through the UWB communication;
calculating a viewing angle with respect to the second electronic device based on the distance, the direction, and the angle between the first electronic device and the second electronic device; and
transmitting the viewing angle.

19. A non-transitory computer-readable storage medium storing instructions that, when executed by a processor, cause the processor to perform the operations of claim 1.

20. A power control module for low-power control of electronic devices in a service area in which the electronic devices comprising a first electronic device and one or more second electronic devices are registered, the power control module comprising:
a communication interface comprising circuitry configured to receive an operation signal of the first electronic device outputting a content over a first display;
a processor configured to: determine an effective device located in the service area from among the second electronic devices in response to reception of the operation signal, obtain interest information including an interest level toward the effective device, and activate a low-power setting for the first electronic device based on the interest information; and
a memory configured to store the interest information.
